(19) United States
(12) Patent Application Publication
(10) Pub. No.: US 2022/0309513 A1
(43) Pub. Date: Sep. 29, 2022

(54) System, Device, and Method for Estimating a Current Condition of Remote Appliances and for Generating a Post-Purchase Warranty for Remote Appliances

(71) Applicant: OLIBRA LLC, Cresskill, NJ (US)

(72) Inventors: Zohar Shinar, Demarest, NJ (US); Christopher Andrew Merck, Vernon, NJ (US)

(21) Appl. No.: 17/210,633

(22) Filed: Mar. 24, 2021

(51) Int. Cl. G06Q 30/00; G06Q 40/08

(52) U.S. Cl. CPC G06Q 30/012; G06Q 40/08; G06N 20/00

(57) ABSTRACT

System, device, and method for estimating a current condition of remote appliances and for generating a post-purchase warranty for remote appliances. A system is configured to obtain and analyze data pertaining to an appliance, at a post-purchase evaluation time-point that is subsequent to the time-of-purchase of the appliance. Based on the data obtained and analyzed, the system determines an Appliance Usage Score Value, indicating characteristics of a manner in which this particular appliance has been utilized, since the time-of-purchase until that post-purchase evaluation time-point. Based on the Appliance Usage Score Value that was determined, the system automatically generates a post-purchase Warranty Proposal or Insurance Proposal for a new warranty or a new insurance for this particular appliance, and automatically determines and generates a premium amount or a price that is included in that post-purchase Warranty Proposal or Insurance Proposal.

### FIELD

Some embodiments relate to the field of appliances and electronic devices.

### BACKGROUND

Millions of people use appliances on a daily basis, at home, at work, and in various venues. For example, a fridge is used to store food at a low temperature; a washing machine is used to wash clothes; a dishwasher is used to wash dishes; a coffee machine is used to prepare coffee; a ceiling fan is used to circulate air; a freezer is used to store food at or below freezing temperature; an oven is used for baking; and so forth.

Sometimes an appliance breaks, or fails to operate at all or as usual. For example, ice buildup may occur in a fridge or a freezer; an ignition unit of a gas range may break; a valve or a pump of a dishwasher may become clogged or break; a drum of a washing machine may stop spinning; a control panel or a door of a microwave oven may break; and so forth.

### SUMMARY

Some embodiments include systems, devices, and methods for estimating current condition of remote appliances and for generating a post-purchase warranty for remote appliances. For example, a system is configured to obtain and analyze data pertaining to an appliance, at a post-purchase evaluation time-point that is subsequent to the time-of-purchase of the appliance. Based on the data obtained and analyzed, the system determines an Appliance Usage Score Value, indicating characteristics of a manner in which this particular appliance has been utilized, since the time-of-purchase until that post-purchase evaluation time-point. Based on the Appliance Usage Score Value that was determined, the system automatically generates a post-purchase Warranty Proposal or Insurance Proposal for a new warranty or a new insurance for this particular appliance, and automatically determines and generates a premium amount or a price that is included in that post-purchase Warranty Proposal or Insurance Proposal.

Some embodiments may provide additional and/or other benefits and/or advantages.

### BRIEF DESCRIPTION OF THE DRAWINGS

FIG. 1 is a schematic block-diagram illustration of a system, in accordance with some demonstrative embodiments.

### DETAILED DESCRIPTION OF SOME DEMONSTRATIVE EMBODIMENTS

The Applicants have realized that a warranty, or an extended warranty, or an insurance, are sometimes sold to consumers with regard to a new appliance concurrently at the time of purchase of the appliance itself. For example, a consumer may purchase a new fridge at a store, and the sale includes a one-year warranty by the seller or by the manufacturer; and the consumer is offered, at the time and place of the purchase, and before the fridge is shipped out or delivered to the consumer, the option to purchase an extended warranty or an insurance plan for five additional years for a premium. Similarly, a consumer may purchase a new toaster from an online store; and during the online checkout process, before the toaster is shipped out or delivered to the consumer, the consumer may be offered to purchase an extended warranty or an insurance plan for the toaster, at an additional price.

The Applicants have realized that such additional warranty or insurance is offered only at the time-of-purchase and at the place-of-purchase (offline, or online); since the seller can be sure that the consumer has not yet tampered with the purchased product, that was not yet shipped out or delivered or handed over to the consumer; and since the seller knows that the product is currently brand-new and non-damaged.

The Applicants have realized that it is very difficult, and sometimes impossible, for a vendor or a manufacturer to offer a paid warranty or a paid insurance plan for an appliance or an electronic device, even five minutes after the purchase was completed. For example, a consumer may walk into an appliance store, pay in full for a 32-inch television, receive it on the spot, and walk out with the television to his car; but in the parking lot, the consumer may accidently drop the television box on the ground, causing the screen to shutter or break. If the vendor or the manufacturer allows a consumer to purchase a warranty post-purchase, then the consumer who has just broke his appliance (e.g., by accident) may purchase such warranty and may immediately (or, after a day or two) request to use the purchased warranty and request a free repair or a free replacement of the damaged appliance.

The Applicants have also realized that some consumers may not be able to purchase an extended warranty or an insurance plan at the time of purchase of the product; for example, due to a budget constraint, or due to lack of knowledge about the complexity or the importance of the appliance that they are purchasing; however, some consumers of this type may wish, or may be able to, purchase a post-purchase warranty or insurance plan if offered to them at a later time, as the consumers may (at that later time) understand the importance of the appliance for his daily operations, or may have sufficient funds to purchase the extended warranty.

The Applicants have also realized that some vendors or manufacturers may be interested in offering and selling a post-purchase warranty or insurance plan, days or even weeks or months after the sale of the product. This may be a source of revenue for vendors or manufacturers, as some appliances are “built to last” and do not break so easily or so often; and some consumers fail to exercise their warranty or their insurance even if they purchased it and the appliance broke.

The Applicants have realized that it is difficult or sometimes impossible, for a vendor or a manufacturer of an appliance, to estimate the likelihood that an appliance that was already sold and delivered, days or weeks or months ago, is currently operating in a good condition or is currently faulty, or is currently worthy to be a subject for a sale of an extended warranty or an insurance plan or is not worthy for such purpose.

Some embodiments include a system that enables a seller or a vendor of an appliance, or a third-party on their behalf (e.g., an insurer, an insurance company, an insurance agent; a warranty provider), to estimate a current condition (e.g., mechanical condition, electrical condition, operational condition) of an appliance that was already sold and delivered to a consumer and that was already owned and/or used and/or controlled by the consumer for days or weeks or months. The system may generate such estimate in a remote way, remotely from the appliance and externally to the venue (e.g., home or office) in which the appliance is located, and without the need for a human representative to visit the venue and to inspect the appliance. The system may then determine, remotely, whether the appliance is in a condition that allows to generate a proposal for warranty purchase or a proposal for an insurance plan purchase for that appliance to that consumer; and further determines, remotely, the premium amount or the price that should be requested from the consumer for such warranty or insurance, based on the estimated condition(s) of the particular product at the current time-point.

In a first example, the appliance is a smart freezer (or fridge). It includes a sensor that senses every time that the door of the freezer is opened, and closed. It counts the number of times per day that the freezer was opened and closed. Optionally, it also includes a timer or a real-time clock, which measures and tracks the time-length of the freezer being open, per day or per week. Three months after the purchase of the freezer, a transmitter of the appliance, or a transmitter that is operably associated with the appliance, transmits the collected data to a remote server of the vendor/manufacturer. The remote server may detect that the freezer was opened, on average, twice per day; and for ten seconds on average each time; thereby indicating that the fridge is used gently, and generating a warranty proposal having a reduced price. Alternatively, the remote sever may detect that the freezer was opened, on average, 15 times per day; and for 45 seconds on average each time; thereby indicating that the freezer was subject to heavy usage that is more likely to cause damage, and therefore may cause the remote server to decline to generate a proposal for warranty or insurance for that freezer, or may generate a proposal that includes an increased price or an increased premium amount due to the heavy usage.

In another example, the freezer (or fridge) also includes a thermostat unit or a temperature controller or regulator; that also monitors the number of times and/or the time-length of periods that the freezer's compressor was operational (rather than being idle); and the freezer may report such data to the remote server. The remote server may detect that the compressor of the freezer was active, on average, only four times per day, and for 30 minutes each time (on average); thereby supporting an automated determination to generate a warranty or insurance proposal for the freezer, and/or to include in it a reduced price or premium amount. In contrast, the remote server may detect that the compressor of the freezer was active, on average, 20 times per day, and for 42 minutes each time (on average); thereby supporting an automated determination to refuse generating a warranty or insurance proposal for the freezer, or to generate such proposal but to include in it an increased price or premium amount due to heavy usage.

In another example, the freezer (or fridge) also includes a thermometer or other temperature sensor that senses and reports the temperature within the freezer; and the freezer may report such data to the remote server. The remote server may detect that the average temperature of the freezer, within the past 30 days, was −20 degrees Celsius, thereby supporting an automated determination to generate a warranty or insurance proposal for the freezer, and/or to include in it a reduced price or premium amount. In contrast, the remote server may detect that the average temperature of the freezer, within the past 30 days, was only 2 degrees Celsius, thereby supporting an automated determination to refuse generating a warranty or insurance proposal for the freezer, or to generate such proposal but to include in it an increased price or premium amount due to an estimate faulty condition of the freezer at current time.

In another example, the freezer is also equipped with biometric sensor(s), able to distinguish among users of the freezer. For example, the handle of the freezer is equipped with a fingerprint scanner, and a fingerprint analysis unit of the freezer may determine that the freezer is used by a single person (e.g., an unmarried persons leaving by himself); such data may be reported or transmitted by the freezer to a remote server, and may support a determination to generate a proposal for insurance or warranty, and/or to include a reduced price or reduced premium in such proposal due to the little usage by the single user. In contrast, the fingerprint analysis may indicate that the freezer is used by 8 persons every day (e.g., a family of two parents and six children; or, eight co-workers in an office), thereby supporting a determination to decline to generate a proposal for insurance or warranty, or to generate such proposal with an increased price or increased premium due to the heavy usage by numerous users. In some embodiments, the number of users may be detected based on image analysis and/or video analysis and/or computer vision; for example, the freezer is equipped with a camera or imagers, that acquires images or videos of the users, and a computer vision analysis is utilized to analyze the captured images or the captured video (e.g., at the freezer itself; or at a remote server to which the images or videos are transmitted) in order to determine the number of different users, thereby supporting the decision whether or not to generate a warranty (or insurance) proposal and/or thereby supporting the determination which price or premium amount to propose. In some embodiments, optionally, the remote server may take into account other extracted data, such as the age of the users; for example, detecting via image analysis that 6 out of the 8 users of the freezer are young children, who tend to open the freezer less gently or to slam its door or to leave it open for long periods of time, thereby leading to a determination to decline generating of a warranty proposal (or insurance proposal) or a determination to increase the proposed price or premium.

In some embodiments, distinguishing among users or counting users of the same appliance may be based on other sensors; for example, based on audio analysis of audio recordings from an acoustic microphone of the appliance, which allows a processor (local or remote) to determine or to estimate the number of users based on voice identification or speaker identification (e.g., counting four users based on voices of an adult male, adult female, child male, and child female); and such data may be used for determining whether or not to generate a warranty (or insurance) proposal, and/or to modify or set the premium or the price for such warranty (or insurance).

In other embodiments, the distinguishing may be performed based on an accelerometer or a force measuring sensor, able to distinguish among users based on the force that they user to interact with the appliance (e.g., the force that the user applies to open or close a door of a freezer or a fridge or a dishwasher or an oven or a washing machine, or the like); thereby enabling the appliance (or a remote server that receives data from the appliance) to count the number of different users, and to take this information into account.

In another example, the appliance is a coffee machine or an espresso machine or a soda machine. It includes a counter or a controller that monitors the number of times that the machine is used; and a transmitter that reports the data to a remote server. The remote server may determine that the coffee machine (or soda machine, or the like) is used once per day, for one minute on average every time; thereby supporting a determination of light use or gently use, and supporting a generation of a warranty proposal or insurance proposal at a reduced price or reduced premium. In contrast, the remote server may determine that the coffee machine (or soda machine) is used 25 times per day (e.g., located in a busy office), thereby supporting a determination to decline generation of a warranty proposal or insurance proposal, or supporting a determination to generate such warranty or insurance proposal at an increased price.

In other embodiments, distinguishing among users or counting users, may be based (in whole or in part) on usage patterns or usage characteristics. For example, the machine may count that it is being used to prepare three espressos per day (on average) and five cappuccinos per day (on average), and may report such data to the remote server. The remote server may utilize a formula to determine the suitable premium amount or the suitable warranty price, based on the actual characteristics and the estimated complexity of actual usage of the machine. For example, a coffee machine that is used, on average, only for making espressos, is less likely to have its Milk Steamer unit fail, since the milk steamer is not used at all for making espresso, and is used only for making a cappuccino or a latte; and therefore, a reduced-price warranty or insurance may be proposed, since the Milk Steamer unit is not used at all by this consumer, or is rarely used. In contrast, a coffee machine that is used heavily for making latte and cappuccino drinks, and not only espresso, is more likely to have its Milk Steamer unit fail or break or become clogged, thereby triggering an increase of the proposed warranty price or insurance premium for such machine.

In another example, a Heat, Ventilation and Air Conditioning (HVAC) unit or system may monitor, track and report the number of times that it operates per day, and the time length (e.g., in minutes or in seconds) that it operates per day; and the number of times, and the time-length of periods, in which a particular unit operates (e.g., the fan; the compressor). The data may be processed locally at the consumer's venue, or remotely at a remote server; and may base a determination whether to propose a warranty or insurance for the HVAC system, and which price or premium to determine for it. For example, an HVAC system that is operational non-stop, 24 hours per day, 7 days a week, may trigger a determination of a higher insurance premium or a higher warranty price, relative to an HVAC system that is operational only from 9 AM to 5 PM at a particular office and is also turned-off during weekends.

Some embodiments may further operate to determine remotely or to estimate remotely, that a particular appliance or device was purchased on date T1 by a consumer, but was then left in an un-opened condition or un-used condition for days or even weeks or months, and only at a later date T2 has actually started to be used by the consumer. Therefore, the system may determine that the condition of that particular appliance, on date T2, or shortly after that date T2, is a new or like-new condition; and this may lead to a determination that this particular appliance is a suitable candidate for proposal of warranty or insurance purchase, even if days or weeks or even months have passed since its purchase, since it is estimated that the product was not used at all during that time-period from the purchase until now.

For example, the Applicants have realized that some appliances are configured, or even heavily configured during their first-ever usage session by the consumer. A laptop computer having serial number HP-123456 was bought on March 1, and remained un-opened for three months, and was firstly opened and used on June 1; the first-ever usage of a laptop, often equipped with a Microsoft (RTM) Windows (RTM) operating system, involves many configurations by the user; for example, setting or selecting the local time, the time zone, the language, the user name, or the like. Once connected to the Internet, the laptop may transmit to a remote server of the vendor or the manufacturer, that the laptop computer having serial number HP-123456, which is already known to be purchased on March 1, was first-ever configured and connected to the Internet on June 1. Therefore, the system may determine, on June 1 or on June 2, that this particular laptop should be regarded as a “brand new” laptop and not as a “three months old laptop”, for purposes of determining whether to propose a warranty or insurance plan for it, and for the purpose of determining the price or premium amount.

In another example, the laptop is purchased on March 1; but on June 1, its owner opens it for the first time and starts using it, without every connecting to the Internet. Only on August 1, the owner connects the laptop to the Internet for the first time. On that date of August 1, the laptop reports the data to the remote server; reporting that it was first-ever used on June 1, and further reporting that it was first-ever connected to the Internet on August 1. Therefore, on August 1, the remote server is able to treat this particular laptop, as a “two months old” laptop, since it was in actual usage for two months (June and July), even if it was connected to the Internet for the first time Five months after the date-of-purchase.

In some embodiments, data that is generated by or sensed by, or measured by or reported by or collected from, an appliance or an electronic device, and particularly from a “smart device” or an Internet-connected device (which is able to transmit data to a remote server, directly and/or indirectly via a Home Automation Hub), may be used by a remote server in order to determine whether or not to generate a proposal for selling a warranty or an extended warranty or an insurance plan for the appliance, and/or to otherwise assist a remote server in eliminating or reducing risk(s) or uncertainties that may be associated with the current condition of the appliance and/or with the possibility or profitability of insuring it or servicing it or repairing it or providing a warranty for it.

The term “appliance” as used above and/or herein may comprise any suitable equipment that utilizes electricity; for example, fridge, freezer, oven, toaster, microwave oven, gas range or cooking range, stove, dishwasher, washing machine, dryer, HVAC, air conditioning unit, heating unit, computer, garage door system, ceiling fan, other types of fan, water filtration unit or system, air purification unit or system, water heater, water boiler, furnace, coffee machine, soda machine, beverage(s) machine, espresso machine, rice cooker, and/or gaming device, gaming console, television, entertainment unit or system, camera, video camera, audio system, video system, computer, telephone units or telephone systems, or other suitable types of electrical devices and/or electrical-and-mechanical devices.

The term “warranty” as used above and/or herein may comprise, for example, an original warranty, an extended warranty, a replacement warranty, a warranty on parts and/or labor, a contract in which a vendor or manufacturer or a servicing entity obligates to repair or replace an appliance or part(s) thereof, or a similar equivalent to a warranty.

The term “insurance” as used above and/or herein may include, for example, an original insurance plan, a re-insurance plan, an extended insurance plan, or other type of contract or transaction in which an entity obligates to pay money if a particular damage occurs to an appliance, or if the appliance breaks down or is non-operational (in whole or in part), or in which the entity obligates to pay for a replacement appliance or to pay for repair of the damaged appliance, or in which the entity obligates to pay to the consumer the original purchase price of the appliance (or a portion of the original purchase price of the appliance), or in which the entity obligates to pay to the consumer the price (or a portion of the price) of a replacement product, or other equivalent scheme that insures a consumer against one or more risk(s) for an appliance.

The terms “warranty price” or “premium amount”, as used above and/or herein, may relate to a monetary amount that the consumer is requested to pay in order to purchase a warranty (or to extend it) or in order to purchase an insurance plan (or to extend it), with regard to a particular appliance.

The terms “reduced” or “increased”, in the context of a warranty price or an insurance premium, may be relative to a “baseline” price or amount. For example, a brand-new fridge is sold for 2,000 dollars; and at the time of purchase, a five-year warranty is offered at a “baseline price” of 100 dollars. One month later, if the fridge was heavily used during that first month (e.g., was opened 25 times per day, for 2 minutes on average each time), the extended warranty may be offered at an “increased price” relative to the “baseline” of 100 dollars, such as, at an increased price of 170 dollars. In contrast, a gently-used fridge, that was opened on average only one time per day, for ten seconds on average each time, during its first month, may be subject to an extended warranty proposal at a “reduced price” of 95 dollars.

In another example, the “baseline” price is not necessarily the price of the insurance or warranty on the day of purchase; but rather, the “baseline” price is the price of such insurance or warranty that is offered at a later date subject to a human inspection of the product that found the product to be in excellent working condition and without faults. For example, a manufacturer may determine in advance, that the “original baseline” price for a five-year warranty on a brand-new freezer on the day of purchase of the freezer is 100 dollars; and that an “updated baseline” price for a five-year warranty on a freezer that is “six months old” but is in excellent working condition and without faults is 150 dollars. Then, the system determines that the particular freezer of Consumer Adam was very gently used during its six months of operation, with only one freezer opening per day for not more than 10 seconds each time; thereby triggering the system to generate for Consumer Adam a proposal to purchase a five-year warranty for his “six months old” freezer at a “reduced price” of 130 dollars, which is reduced from the “updated baseline” price for no-fault six-month-old freezers. In contrast, the system determines that the particular freezer of Consumer Bob was very heavily used during its six months of operation, with 26 opening-and-closing events of the freezer per day, and with an average freezer-is-open time of 18 seconds per event, in the past six months; thereby triggering the system to generate for Consumer Bob a proposal to purchase a five-year warranty for his “six months old” freezer at an “increased price” of 190 dollars, which is increased from the “updated baseline” price for no-fault six-month-old freezers.

Some embodiments may collect and analyze data in order to remotely estimate the time-of-purchase of a product, which is not always known to the manufacturer who may wish to propose an extended warranty or an insurance plan for the product. The date of purchase is used as a factor in determination of insurance and reinsurance or warranty for appliances. Using data that is collected prior to and after the appliance is connected to the internet, optionally correlated with usage profile of similar users, the system may remotely estimate or determine the actual date of purchase.

The factors or parameters that the system may use, in order to estimate the date of purchase of an appliance, or the date of first-ever usage (particularly, the date of first-ever offline usage, without connection to the Internet), may include for example: (a) the number of hours of operation before the appliance was first-ever connected to a communication network (e.g., to the Internet); the geographic location of the appliance or the consumer; the type or model of the appliance; the actual or the typical weather conditions in the region where the appliance or the consumer are situated; and/or other parameters.

In a first example, a portable air-heating unit is purchased online on July 1 by a consumer located in Miami, Fla., and is delivered to the consumer on July 3. Two months later, on September 3, the consumer is inquiring whether he may purchase an extended warranty, and mentions his current address in Miami. The system may estimate that the portable air-heating unit was not used, at all or mostly, during the months of July and August in Miami which has a hot weather in those two months, and therefore may handle the request as a request for insuring or for warrantying an “almost new” or “almost never used” heating unit, even though it was purchased two months before.

In another example, a freezer is purchased by the same consumer in Miami on July 1, and is delivered to the consumer on July 3. Two months later, the system may determine based on the location and its general weather conditions, that the freezer has been operating heavily during the two months of the summer, and therefore, may take this into account when determining the price for appliance insurance or warranty for this freezer at this location.

In some embodiments, the system may utilize a “big data” analysis unit or an Artificial Intelligence (AI) engine, to analyze the characteristics of the usage of the appliance by a particular user, and to match or compare them against data collected from other appliances of the same type or of a similar types; particularly immediately after the appliance is connected to the Internet for the first time ever; to create a user profile or an appliance usage profile that would match the particular user and the particular appliance. Some embodiments may analyze the data and may detect a “wow factor” or an “excitement factor”: the Applicants have realized that for some appliances, a first-ever usage of the appliance is often associated not necessarily with heavy operations of configuring the appliance (as occurs with a new laptop computer), but rather, is often associated with a prolonged usage session in which the new consumer tries many different features of the new appliance, one after the other; and such behavior, realized the Applicants, characterizes a first-ever usage after first-ever installation of the appliance.

In a first example, Consumer Adam and Consumer Bob and Consumer Carla have purchased a smart ceiling fan or an Internet-connection capable ceiling fan, on the same date, March 1. Consumer Adam has installed his ceiling fan on March 2, and has immediately connected it to the Internet. The smart fan reports to a remote server that it (the smart fan) is online, and the remote server knows that this smart fan of Consumer Adam has been operational since March 2. However, Consumers Bob and Carla behave differently. Consumer Bob installs his ceiling fan on March 2; but only three months later, on June 2, he connects his ceiling fan to the Internet. In contrast, Consumer Carla keeps her ceiling fan in its box for about three months; and only on June 2 she installs her fan and also connects it to the Internet. The smart fan of Bob has been counting and measuring internally, within the smart fan, while being offline, its hours of operation; and it reports to the remote server, or June 2, that it has been operating (spinning its blades, circulating air) for 450 hours already. In contrast, the smart fan of Carla, once it is connected to the Internet on June 2, reports to the remote server that it has been operating (spinning its blades, circulating air) for 3 minutes so far. Accordingly, the remote server may generate differential proposals for warranty or insurance of the ceiling fan, to each one of the three users: to Consumer Adam, a proposal that is based on the knowledge that his fan has been operational for three months and has accumulated a certain number of operational hours already; to Consumer Bob, a proposal that is based on the knowledge that his fan has been operational for 450 hours; and to Consumer Carla, a proposal that is based on the knowledge that her fan has been operational for 3 minutes so far. The system may typically generated the lowest price proposal to Consumer Carla, in the above example, due to the fact that her fan was not used at all until that time point.

In some embodiments, each ceiling fan measures or counts internally, the number of minutes (or seconds, or hours) in which it is active and operational (e.g., rotating its blades), and may report such data to a remote server. In some embodiments, additionally or actively, an “excitement factor” may be determined, if the fan (locally) or the remote server (which receives data about the fan's operation) detects that the user has performed a series of various commands or actions that are pre-defined in the system as characterizing a first-ever usage session; for example, checking consecutively all the rotating speeds of the fan, checking consecutively the lighting options of the illumination unit, operating the ceiling fan via a remote control unit and also via a pull-chain consecutively, trying a “sleep mode” of a fan and then canceling it, and so forth; thereby determining remotely that the fan has just been operated for the first time ever, based on the excessive number of different commands or actions that were entered by the user and the characterize a first-ever usage of that appliance.

Using big data and AI algorithms, comparing the usage behavior immediately after the device is connected to the Internet, may allow the system to create a special usage profile (“excitement effect” or “excitement factor” or “excitement session” associated with each appliance), which reflects or represents typical usage immediately after first installation of the appliance; and this data or profile may be correlated (or, not correlated) to the number of hours that the appliance was already used prior to connecting it to the Internet.

The “excitement effect” may vary based on device type (e.g., a ceiling fan, a freezer) and the type of user who is installing or using the device. For example, in the case of a ceiling fan, once the device is freshly installed, users usually try out the majority of the features to test that the installation is correct and that the device does not vibrate when operating at high speeds. The user often tests, in such first-ever usage session, all the ceiling fan speeds, as well as the light and dimmer functions, within less than 30 minutes. This behavior, optionally correlated with the counted number of operational hours of operation so far, and/or optionally correlated with actual weather conditions and/or general weather conditions, may indicate to the system whether the device was just now installed.

In some embodiments, correlating claim data and predictive failures data regarding specific models or types of appliances, can also be used to determine the price for the warranty or insurance, regardless of the user profile. For example, if there is a specific model of appliance that demonstrates failures more frequently relative to a baseline threshold, then its warranty price is increased by the system. The system may collect or receive data which indicates, for example, that for Ceiling Fan Model AABB, approximately 35 percent of such ceiling fans, in the State of Florida, were called in for repair within their first year; whereas, for Ceiling Fan Model CCDD, only 5 percent of such ceiling fans, in the State of Florida, were called in for repair within their first year. The system may utilize such data in order to determine or adjust the price of the warranty or insurance that is offered to the consumer of a particular fan.

Some embodiments may further take into account, in determining whether or not to generate a proposal for warranty or insurance for an appliance, and/or in determining which price or premium amount to generate for it, the rating or scores or reviews or ranking that the particular appliance model has received from a crowd of consumers, in a marketplace (e.g., Amazon.com, eBay.com, Walmart.com, or the like), and/or the Net Promoter or Net Promoter Score (NPS) which may be calculated or obtained for that appliance. In a first example, an appliance that is Ceiling Fan Model AABB, has 2,500 reviews on Amazon.com, with an average review score of 4.5 stars; and with a contextual analysis of the reviews showing that only 3% of the reviews mentioned the words “problem” or “broke” or “broken”; thereby enabling the system to support a determination to propose a sale of a warranty or an insurance for that particular appliance model, and/or to couple that proposal with a reduced price or reduced premium. In contrast, an appliance that is Ceiling Fan Model CCDD, has 450 reviews on Amazon.com, with an average review score of 1.5 stars; and with a contextual analysis of the reviews showing that 67% of the reviews mentioned the words “problem” or “broke” or “broken”; thereby enabling the system to support a determination to avoid proposing a sale of a warranty or an insurance for that particular appliance model, or to generate such proposal with an increased price or premium. Some embodiments may similarly calculate or obtain the Net Promoter Score (NPS) for the particular appliance model; for example, the percentage of customers that rated their likelihood to recommend that appliance to a friend as 9 or 10 (“Promoters”), minus the percentage of customers that rated this at 6 or below (“Detractors”) on a scale from 0 to 10; while respondents who provide a score of 7 or 8 are referred to as “Passives” and do enter into the overall percentage calculation; the result of the calculation is expressed without the percentage sign. The NPS may be taken into account by the system, for determining whether or not to generate a warranty or insurance proposal, and/or for determining the price or premium of such proposal.

In some situations, the cause for a claim for repair of an appliance is actual failure and/or perceived shortcoming of the appliance. Through analysis of operational data collected from the appliance itself, as well as direct communication with the users, the level of satisfaction with the product can also be used to determine the price of warranty.

For example, products having high review scores, online at e-commerce websites, and/or offline when interacting with users (e.g., through a computer or an application or “app” or website that asks the user how likely he is to recommend the appliance to his friends), the system may reach a lower claims percentage value and therefore may enable a reduced pricing for the warranty or insurance. For example, an Internet-connected fridge of Model FFGG may ask its users, via its touch-screen or via an application is connects to the fridge, how likely is the user to recommend the fridge to friends; if 90% of the users choose 9 or 10 (on a scale of 0 to 10), and the system collected such survey information from 500 users of that fridge model, then the system may determine a reduced price for warranty or insurance for that particular model of appliance. Similarly, if only 12% of surveyed users would recommend it to their friends, the system may use such data to increase the price for warranty or insurance, or may decline to generate a proposal for warranty or insurance.

Some embodiments may utilize diagnostics data and other data from the appliance itself, which may indicate an actual failure or a potential failure or a probably-upcoming failure of the appliance or a part thereof. For example, a smart fridge may report the level of electricity current that is consumed by the compressor of the fridge; a remote server may analyze the data, and may detect that the fridge of Consumer Adam reports an increased level of electric current that is used, thereby indicating that its compressor is currently faulty or abnormal; and triggering the system to decline to generate a warranty proposal, or to increase the warranty price. Similarly, am abnormally low level of electric current may indicate a fault with the appliance, triggering a similar result.

In some embodiments, data about the hours (or time periods) in which the appliance was used, may be used for reinsurance or warranty determination of the appliance. Even if the appliance is not new, and was not purchase recently, based on the “excitement factor” a warranty or insurance product can still be generated and offered, based on the number of hours used, optionally compared with the usage of similar users.

For example, a window Air Conditioning unit that is used but has a very low number of hours of actual usage (e.g., 10 hours of usage in total), in an area with generally hot weather conditions (e.g., Florida), may indicate to the system that this user is not an extensive user, and thus the likelihood of a failure for this appliance is low, and the system may generate a warranty proposal or an insurance proposal, at a reduced price or rate.

The system may further detect extensive usage or excessive usage, particularly when segmented by user and/by model and/or by location. The Applicants have realized that the cumulative number of hours of operation that already elapsed, is typically a useful indication of the remaining life expectancy of an appliance, or the likelihood that it would need a service or a repair within the next N months. As the user-base increases, the warranty cost can be tailored not only to the user's usage profile, but also to the specific model of appliances; based on an analysis that indicates that Fridge Model AABB, in Florida, having accumulated 2,000 hours of operation, is likely to fail within the next 500 hours of operation; whereas, Fridge Model CCDD, in the same conditions, is not likely to fail within the next 500 hours of operation.

Some embodiments may utilize Venue Occupancy as predictor of failures of an appliance. For example, a freezer of a single guy, is generally less likely to fail than a freezer utilized by a family having six children. The number of occupants may be detected by various means, such as, camera and computerized vision analysis, microphone and audio analysis, fingerprint analysis, force and acceleration analysis, usage patterns analysis, or the like; and may be taken into account by the system.

Some embodiments may take into account temperature fluctuation, of the appliance and/or within the appliance and/or near the appliance. For example, a thermostat that is located near a door or a window of a house, will trigger the Air Conditioning system or the heating system to operate more often, relative to a thermostat located away from such door or window or in a location where the temperature does not alternate quickly. In some embodiments, the system may obtain such location from a human installer of the appliance, or from the consumer himself during the warranty proposal process, or via other means (e.g., from images captured by the appliance, of its surroundings), and may take such information into account.

Some embodiments may detect abusive usage of the appliance, or ignorance or mistakes of the user related to appliance usage. The user profile is not limited to only how extensively the appliance is used, but also to how (in which manner) it is used. For example, if a fridge door is opened for a longer period of time and/or more frequently, the compressor of that fridge will wear down faster. Data about such opening is measured and analyzed, and is taken into account.

In accordance with some embodiments, the reliability of electric power supply to a venue, and/or the number or frequency of power outages in a venue, may have an impact on the longevity of appliances, particularly high-power appliances such as fridges, freezers, A/C units, HVAC systems, or the like. Using power integrity in the home or in the venue, as predictor of failure, may be performed by the system based on data collected from the appliance itself, or even from other appliances in the same venue. In a first example, the smart fridge of Adam is Internet connected, and reports autonomously the number and time-length of power outages in Adam's home; which are taken into account for determining a warranty for that fridge. In a second example, the fridge of user Bob is not Internet connected at all; however, Bob also owns a smart or Internet-connected television (or cable box), that reports to the remote server about its own power outages; the same vendor has sold to Bob both the television and the fridge, and delivered them to the same home addresses; therefore, data about power outages in that home, that is collected and transmitted by the smart television to a remote server, can be used by the system to assess the number of power outages that the entire venue suffered, which in turn has deteriorated the longevity of the compressor of the fridge; thereby enabling the system to take the power reliability information of the venue, for warranty or insurance purposes of the fridge, even if the fridge is not Internet-connected and does not transmit any data to any remote server.

Some embodiments may autonomously distinguish between installation time and purchase time of an appliance; such as, based on a first-ever usage session that is characterized by an “excitement factor” or by a “testing session” in which the user checks many different features of the new appliance for the first time. The system may generate the warranty proposal based on the determined date in which the appliance was actually installed and/or brought online or Internet connected, and not on the date in which the appliance was purchased or delivered to the consumer.

Some embodiments may take into account predictive maintenance information or data. For example, an appliance may report autonomously that a particular part of it has failed, or requires maintenance, or should be serviced within N days or weeks; and this may be taken into account by the system. For example, an Internet-connected HVAC system or furnace, may report that an annual maintenance is due within the next month, or that an annual maintenance was not performed for the last five years; and the remote server may take this information in adjusting or determining the warranty price or insurance premium.

Some embodiments may capture audio or acoustic information from the appliance, and may utilize it or take it into account in determining warranty or insurance price. For example, a smart fridge or a smart HVAC system may be equipped with an acoustic microphone, which may provide audio that indicates that a compressor is noisy or rattling; and this information may be taken into account to increase the warranty price or the insurance premium, or to decline to propose a warranty or an insurance. Furthermore, an Internet-connected audio system or home automation system, or an Alexa compatible device or a voice-operated device, may already include a microphone; and may record ambient sounds from the venue, which may indicate to a remote server that there is a nearby fridge with a noisy compressor, or may similarly capture a prolonged beeping sound that some fridges generate if their door is left open for a long period of time; and therefore, a request for a warranty for that fridge in that venue, may be declined or may be priced higher, based on analysis of the ambient audio that was recorded or captured by the nearby microphone of an entirely different device; and even if the fridge itself is not Internet connected and is not equipped with a microphone of its own. Similarly, an Internet-connected security camera within the venue, may record or may transmit video that shows the fridge shaking or vibrating, or that shows the fridge door remaining open for several minutes every time; and based on the video analysis, that was recorded or captured by the nearby camera of an entirely different device, a request for a warranty for that fridge in that venue may be declined or may be priced higher; even if the fridge itself is not Internet connected and is not equipped with a camera.

In some embodiments, electric current consumption of the appliance may be measured, for example, by a smart power outlet that reports the power consumption to a remote server. The remote server may monitor and track the current consumption footprint of the appliance, and may detect changes that indicate faulty operation or faulty parts; or which may indicate an old age of the appliance, or an abusive manner of usage, or the condition of its parts (e.g., its compressor); and this information may be taken into account by the system, when determining whether to propose a warranty or insurance, and which price or premium to determine for it.

In some embodiments, based on the user usage profile immediately after first connection to the network, and comparing that usage profile with similar users based on location and type of appliance (e.g., ceiling fan) that is used, the system may determine if this is the first time that the appliance is ever used, or was it used for a while before and was only now connected to the network or the Internet. The system may detect an “excitement factor” mode of operation by the user in a first-ever usage session, and/or may correlate the operational characteristics of the current usage session with past information that the system may have about this specific user or similar users, in combination with data from within the appliance itself regarding the number of minutes or hours that it was used cumulatively so far. The system may thus detect an appliance, that was used for many weeks or months, before being connected to the Internet or the home network.

Some embodiments may utilize dynamic pricing of the warranty or insurance, based on characteristic of usage of the particular appliance by the particular user. For example, the system may take into account: (a) Frequency of use; how often is the appliance turned on and off, or engaged with, during the day or in a given period of time and season; (b) Type of use; whether the coffee machine is utilized for a simpler function (espresso) or a more complicated function that involves additional machine parts (cappuccino); (c) Abuse of the appliance; detecting that the freezer door is left open for minutes each time, or detecting that the use changes the rotation speed of the ceiling fan every few minutes, or detecting that the user changes rotation direction of a fan while the blades are still rotating without waiting for the blades to stop, or other abusive usage characteristics; or detecting physical or mechanical forces or damage to the appliance, based on data from an accelerometer or compass units or gyroscope of the appliance (e.g., gyroscopes of the fridge report that the user slam-shuts the fridge door every time); (d) sensed temperature, within the appliance and/or in the vicinity or venue of the appliance, as sensed and reported by the appliance itself, or as sensed and reported by nearby appliance(s) in the same venue; such as, a nearby smart thermostat of a smart HVAC system, or a nearby smoke detector, continuously or frequently reports high temperature in the kitchen, thereby indicating to the system an increased likelihood that the nearby fridge would fail or malfunction; (e) tracking the cumulative number of hours (or minutes) of operation, of the appliance or of a particular part of it (e.g., only its compressor, or only its fan), optionally taking into account also the geographic location of the venue, the type of venue (e.g., a home, or an office that is closed on weekends and evenings), in-house location of the device (e.g., a ceiling fan located in a bedroom is expected to operate 10 hours per day, while a ceiling fan located in an open patio is expected to operate 1 hour per day).

Some embodiments may predict that a service claim or a warranty claim or an insurance claim would likely be upcoming soon, or within N days or weeks from now, based on one or more predicting factors or rules. For example, a contextual analysis of 500 user reviews for a particular model of an appliance, may indicate that 40% of reviewers have mentioned that the appliance has failed or malfunctioned within 3 months of initial use. The data may be obtained based on SKU number of model number of the appliance, from online sources or databases or marketplace or reviews website; or may be collected from actual users via an app or via a website that surveys consumers about their appliances.

Some embodiments may remotely estimate the current condition of a fridge or a freezer, based on multiple data-points that may be obtained or collected; for example, acoustic data, vibration data, electric current consumption, door opening and closing data, or the like; optionally utilizing acoustic signatures or audio analysis to detect or to determine a faulty compressor or a malfunctioning compressor or fridge, or to determine a frequency of operation or oscillation of a component (compressor, fan); optionally utilizing audio captured by a nearby device and not by the fridge itself; optionally utilizing a Hall-effect sensor to track or monitor the magnetic field of the fridge or the compressor (or other appliance or component) and to determine or predict malfunctions; determining the number of times that a fridge door was open, based on the number of times that the compressor started to operate; detecting that the fridge is located in a venue or a room having a high ambient temperature; detecting temperature fluctuations within the fridge itself; or the like.

In some embodiments, power outages to the venue may affect the long term health of the appliance or its components. The system may measure the number of power outages or power surges, their timing, their frequency, their time-length, their magnitude, and/or other factors; and may also take into account whether the transmitter that reports such data is embedded within the appliance itself (e.g., a transmitter of an Internet-connected fridge) or is located elsewhere in the venue (e.g., a home automation hub). For example, some embodiments may determine or may define in advance, that if a home automation hub loses power, then it does not necessarily mean that the fridge has also lost power, as often the fridge is connected to its own, separate, electric breaker; whereas, other embodiments may use a more conservative approach, in which any power outage anywhere in the same venue is taken into account when estimating remotely the probability of malfunction of any appliance in that venue.

In some embodiments, the probability of malfunction of a water heater or a water boiler unit, may be estimated remotely by taking into account various factors; such as, the number of times that it was turned on, the time-length of actual operation (actual heating); frequent fluctuations in the water level within the water tank, which indicate frequent use of the boiling water and thus extensive usage of the heating components; estimation of a water leakage from the water tank or from a hot water pipe, based on one or more measured parameters (water level, water temperature, acoustic footprint of the water tank and its surrounding which include an audible sound of dripping water, video recording of the water tank and its surrounding which indicate a visible water leakage or a rusty floor due to leakage); or the like.

Some embodiments may estimate the condition of an Air Conditioning unit or an HVAC system; by taking into account, for example, temperature fluctuations as measured by the thermostat of the system itself, or as reported by a thermometer of a different device in the same venue; location of the thermostat in an area that is exposed to sharp or frequent fluctuations of temperature (e.g., next to a window or door); power outages or power surges in the venue, and their frequency and length and characteristics; or the like.

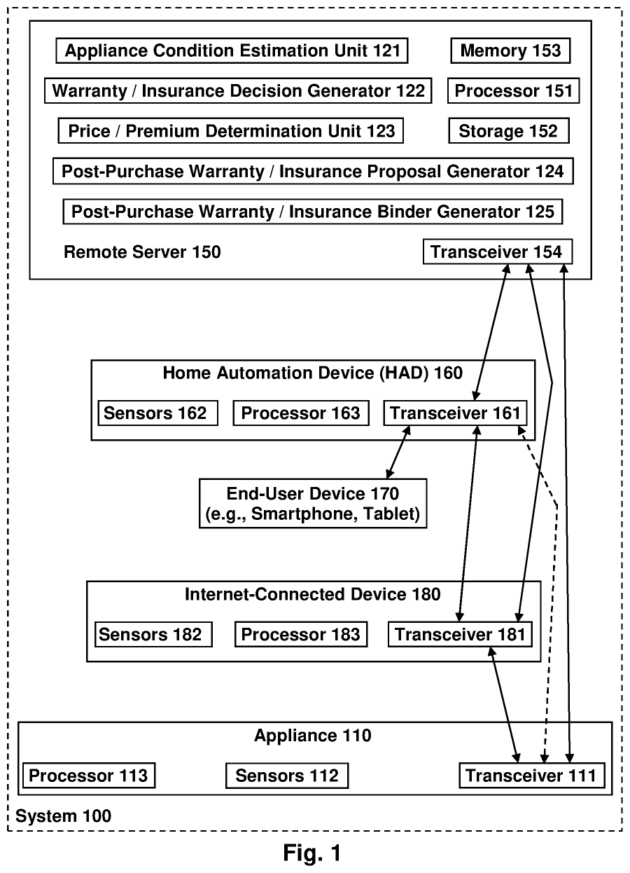

FIG. 1 is a schematic block-diagram illustration of a system 100, in accordance with some demonstrative embodiments. System 100 may comprise, for example, an Appliance 110 that was already purchased by a consumer and is already located at a consumer's venue (e.g., home, office). In some embodiments, Appliance 110 may communicate with a remote server 150, directly via a wireless transceiver 111 which may be included in Appliance 110; and/or indirectly, via an optional Home Automation Device (HAD) 160 which may be part of a smart home automation system and may be able to communicate with one or more appliances over wireless communication links and may also be able to communicate with an end-user device 170 (e.g., smartphone, tablet, laptop computer, desktop computer) of the same consumer who owns Appliance 110; and/or indirectly via another Internet-connected device 180 (or Internet-connected appliance) which may be in communication with such remote server 150 and/or with such Home Automation Device 160 and which may optionally also be in local communication (e.g., via a short-distance wireless communication link, or a low-energy wireless communication link, or via a wired communication link) with Appliance 110.

In some embodiments, Appliance 110 may comprise one or more sensors 112 which may monitor and/or sense and/or track and/or measure data, which may then be processed locally by a processor 113 of Appliance 110, and/or which may be transmitted (directly and/or indirectly) from Appliance 110 to Remote Server 150 for processing there. Such sensors 112 may comprise, for example, a camera, a microphone, a vibration sensor, one or more accelerometers and/or gyroscopes, an electric current measuring unit, an electric voltage measuring unit; a sensor able to count or track the number of times in which Appliance 110 is activated or engaged with or operated (e.g., the number of times that a coffee machine is used per day; the number of times that a freezer door is opened per day); a sensor able to track or measure the number of seconds or minutes or hours that Appliance 110 is operational (e.g., the number of minutes per day in which a coffee machine is actually operational and preparing coffee; the number of minutes per day in which a microwave oven is actually operational and heating-up food); a sensor able to track or measure, separately, the number of times and/or the length of time in which a particular component of Appliance is 110 is operational (e.g., counting the number of times that the Door component of a freezer is opened; counting the total number of minutes per day in which the Door component of a freezer is open; counting the total number of times per day that a Compressor unit of a freezer is started; counting the total number of minutes per day that the Compressor unit of a freezer is operational; counting the number of times per day that a Milk Steaming Unit of a coffee machine is used, separately from the coffee machine preparation unit; counting the total number of minutes per day in which the Milk Steam Unit of a coffee machine is operational and is steaming milk, separately from the number of minutes in which the entire coffee machine is used; or the like).

Optionally, one or more sensors 162 of the Home Automation Device (HAD) 160 may similarly sense, track, monitor, collect and/or measure data, which may pertain directly or indirectly to the operational condition and/or operational status and/or operational performance of Appliance 110; and such data may be transmitted via a transceiver 161 to the remote server 150, directly or indirectly. For example, the Home Automation Device (HAD) 160 may be equipped with a camera that captures images and/or videos that depict (among other things, or by itself) the Appliance 110; or a microphone capturing audio or ambient audio that may include noises or audio generated by Appliance 110; or vibrations sensed by an accelerometer or gyroscope or vibration sensor of the Home Automation Device (HAD) 160; and such data may be transmitted to remote server 160 for analysis there and for deducing there, remotely, the current operational condition of Appliance 110. Optionally, Home Automation Device (HAD) 160 may comprise its own processor 163, which may perform locally all or part of the analysis for deducing the current operational condition of Appliance 110; and may transmit the (partial and/or full) analysis results to remote server 150.

Optionally, one or more sensors 182 of the Internet-Connected Device 180 may similarly sense, track, monitor, collect and/or measure data, which may pertain directly or indirectly to the operational condition and/or operational status and/or operational performance of Appliance 110; and such data may be transmitted via a transceiver 181 to the remote server 150, directly or indirectly. For example, the Internet-Connected Device 180 may be equipped with a camera that captures images and/or videos that depict (among other things, or by itself) the Appliance 110; or a microphone capturing audio or ambient audio that may include noises or audio generated by Appliance 110; or vibrations sensed by an accelerometer or gyroscope or vibration sensor of the Internet-Connected Device 180; and such data may be transmitted to remote server 160 (directly by Internet-Connected Device 180, and/or indirectly via the Home Automation Device (HAD) 160) for analysis there and for deducing there, remotely, the current operational condition of Appliance 110. Optionally, the Internet-Connected Device 180 may comprise its own processor 183, which may perform locally all or part of the analysis for deducing the current operational condition of Appliance 110; and may transmit the (partial and/or full) analysis results to remote server 150.

Remote Server 150 may comprise a processor 151 able to execute code or programs or machine-readable instructions (e.g., a Central Processing Unit (CPU), a Digital Signal Processor (DSP), an Integrated Circuit (IC), a logic unit, or the like); a storage unit 152 to store received data and/or processed data (e.g., hard disk drive, solid state drive); a memory unit 153 able to store data for short term (e.g., Random Access Memory (RAM) memory, Flash memory); a transceiver 154 able to send and receive data using one or more wireless communication protocols (e.g., Wi-Fi communication, cellular communication, TCP/IP communication); and other suitable components (e.g., input unit such as keyboard and mouse; output unit such as display unit; power source; or the like).

Remote Server 150 and its processor 151 and other components may be configured or programmed to receive data from Appliance 110, and/or to receive data that pertains (directly or indirectly) to Appliance 110 from the Home Automation Device (HAD) 160, and/or to receive data that pertains (directly or indirectly) to Appliance 110 from the Internet-Connected Device 180. Then, an Appliance Condition Estimation Unit 121 of Remote Server 150 may analyze the received data, optionally in combination with data from other sources (e.g., location data about the consumer's location and/or the Appliance 110 location; weather data for such location; pre-defined rules or parameters for this type of Appliance 110; or the like), and to generate an Estimated Appliance Condition Score in a pre-defined range (e.g., from 0 to 100; whereas 0 indicates that Appliance 110 is completely non-operational or completely broken, and 100 indicates that Appliance 110 is in excellent and new or almost-new operational condition and/or physical condition), that indicates the estimated overall current condition of Appliance 110. The generated Estimated Appliance Condition Score is then utilized, optionally in combination with other data or parameters, by a Post-Purchase Warranty/Insurance Decision Generator 122, which generates a determination whether or not the specific Appliance 110, with its current, specific, estimated condition, and based on one or more pre-defined decision rules, is suitable to become a subject for a new Warranty or for a new Insurance or Re-Insurance plan. If the decision or the determination is positive, then, a Price/Premium Determination Unit 123 proceeds to determine or calculate the price or the premium (e.g., per time-unit, such as per year or per month) that would be suitable for such Warranty or Insurance with regard to this specific Appliance 110 at this specific time-point, based on pre-defined rules and threshold values. Then, a Post-Purchase Warranty/Insurance Proposal Generator 124 may operate to generate a message representing such proposal and further indicating the proposed price or premium, as determined. Then, the message may be sent or displayed or conveyed to the consumer who owns or operates Appliance 110; and if the consumer accepts the proposal, and (optionally) also provides payment (e.g., via credit card, via debit card, via other online payment means) then a Post-Purchase Warranty/Insurance Binder Generator 125 proceeds to generate a binder or token or file or contract or record or other instrument or data-item that indicates that there exists now a binding warranty or insurance plan for that specific Appliance 110, optionally also updating a record in a database (e.g., vendor database, manufacturer database, warranty provider database, insurer database, servicing entity database) to reflect that such warranty or insurance is now existing and active, and optionally also sending a copy of such binder to the consumer and/or to one or more third parties or entities.

Some embodiments may determine warranty (or insurance) price or premium, and whether or not to propose it, based on remotely-estimated device usage and/or remotely-estimated device condition of the Appliance. For example, the system comprises one or more processors, operably associated with one or more memory units; wherein the one or more processors are configured: (a) to obtain and analyze data pertaining to an appliance, at a post-purchase evaluation time-point that is subsequent to the time-of-purchase of said appliance; (b) based on the data obtained and analyzed in (a), to determine a Device Usage Score Value, indicating characteristics of a manner in which said appliance was utilized, since said time-of-purchase until said post-purchase evaluation time-point; (c) based on the Device Usage Score value determined in (b), to automatically generate a Warranty Proposal for a new warranty for said appliance, and to automatically generate a premium amount that is included in said Warranty Proposal.

Some embodiments may remotely estimate or may remotely detect “device abuse” or “device mis-use” with regard to the Appliance. For example, the remote server may be configured: (A) to determine, based on the data obtained and analyzed in (a), that said appliance was abused by a user of said appliance during at least one time-point that is between said time-of-purchase and said post-purchase evaluation time-point; (B) to generate said premium amount for said Warranty Proposal, by taking into account a determination in (A) of a post-purchase abuse of said appliance.

Some embodiments may remotely estimate or may remotely detect that the Appliance has been subject, generally, to continuous proper use (e.g., and to no abuse, and to no mis-use). For example, the remote server may be configured: (A) to determine, based on the data obtained and analyzed in (a), that said appliance was properly utilized continuously by a user of said appliance during a time-period that begins at said time-of-purchase and that ends at said post-purchase evaluation time-point; (B) to generate said premium amount for said Warranty Proposal, by taking into account a determination in (A) of post-purchase continuous proper utilization of said appliance by said user from said time-of-purchase until said post-purchase evaluation time-point.

Some embodiments may remotely estimate or may remotely detect that the Appliance was not used at all, since its purchase until today (until the current time-point, or the current evaluation time-point); thereby determining, remotely, the “true age” of the Appliance. For example, the remote server is configured: (A) to determine, based on the data obtained and analyzed in (a), that said appliance was not in use since the time-of-purchase of said appliance until the date of said post-purchase evaluation time-point; (B) to generate said premium amount for said Warranty Proposal, by taking into account a determination in (A) that said appliance was not in use since the time-of-purchase of said appliance until the date of said post-purchase evaluation time-point.

Some embodiments may remotely estimate the number of minutes (or hours, or days) that the Appliance has been used, since its purchase and/or since its manufacturing date (e.g., and even if such purchase date or manufacturing date is not known at all to the remote server) and/or since its first-ever usage and/or since its first-ever installation or box-opening or package-opening and/or since its first-ever power-on event; particularly if the Appliance is powered on and has an internal counter of usage events or time of usage. For example, the remote server is configured: (A) to determine, based on the data obtained and analyzed in (a), that said appliance was in use for not more than M minutes since the time-of-purchase of said appliance until said post-purchase evaluation time-point; wherein M is a threshold value that is pre-defined per type or per model of appliance; (B) to generate said premium amount for said Warranty Proposal, by taking into account a determination in (A) that said appliance was in use for not more than M minutes since the time-of-purchase of said appliance until said post-purchase evaluation time-point.

Some embodiments may remotely estimate that the Appliance has been connected to the Internet less than M minutes cumulatively so far. The remote server is configured: (A) to determine, based on the data obtained and analyzed in (a), that said appliance was connected to the Internet for M minutes since the time-of-purchase of said appliance until said post-purchase evaluation time-point; wherein M is a threshold value that is pre-defined per type or per model of appliance; (B) to generate said premium amount for said Warranty Proposal, by taking into account a determination in (A) that said appliance was connected to the Internet for M minutes since the time-of-purchase of said appliance until said post-purchase evaluation time-point.

In some embodiments, the remote server is configured: (A) to determine, remotely and externally to said appliance, a number of minutes (M1) that said appliance was connected to the Internet since the time-of-purchase of said appliance until said post-purchase evaluation time-point; (B) to generate said premium amount for said Warranty Proposal, by taking into account a determination in (A) of the number of minutes (M1) that said appliance was connected to the Internet since the time-of-purchase of said appliance until said post-purchase evaluation time-point.

Some embodiments may remotely estimate, and may take into account, both the cumulative Offline usage length and the cumulative Online usage length, since purchase date. The remote server is configured: (A) to determine, remotely and externally to said appliance, a first number of minutes (M1) that said appliance was connected to the Internet since the time-of-purchase of said appliance until said post-purchase evaluation time-point; (B) to receive from said appliance, a message indicating a second, greater, number of minutes (M2) that said appliance was operable and in use, regardless of being offline or online, since the time-of-purchase of said appliance until said post-purchase evaluation time-point;

(C) to generate said premium amount for said Warranty Proposal, by taking into account both: (i) a determination in (A) of the first number of minutes (M1) that said appliance was connected to the Internet since the time-of-purchase of said appliance until said post-purchase evaluation time-point, and (ii) the second number of minutes (M2) in which said appliance was operable and in use regardless of being offline or online.

Some embodiments may remotely estimate, and may take into account, an “excitement factor” that can be detected remotely, such as by detection of performance of a variety of tasks of the appliance within N minutes during its first-ever usage session or during its first-ever Internet-connected usage session. For example, the remote server is configured: (A) to determine, remotely and externally from the appliance, that said appliance was first-ever connected to the Internet on day D1; and (B) to detect that during a usage session of said appliance, which is the first-ever Internet-connected usage session of said appliance, the appliance was operated by a user to perform at least K different tasks within not more than M minutes; wherein K and M are threshold values that are pre-defined per type-and-model of appliance; and (C) based on a detection in (B), to determine that said first-ever Internet-connected usage session, is also a first-ever usage session of said appliance, and to determine that said appliance was not used at all by said user prior to day D1; and (D) to generate said premium amount for said Warranty Proposal, by taking into account a determination in (C) that said first-ever Internet-connected usage session is also a first-ever usage session of said appliance.

Some embodiments may take into account the geographic location of the Appliance and/or of the consumer (e.g., obtained from a user profile or a purchaser profile of the consumer, which may be based, for example, on an online record of the online purchase of the Appliance by the consumer); and optionally also utilizing a user profile repository that may be analyzed to further enable estimation of the purchase date. The remote server is configured: (A) to determine, based on the data obtained and analyzed in (a), that said appliance was located at a particular geographic region since the time-of-purchase of said appliance until said post-purchase evaluation time-point; and (B) to generate said premium amount for said Warranty Proposal, by taking into account a determination in (A) of said particular geographic region.

Some embodiments may take into account the geographic location (of the Appliance and/or the Consumer) and also the weather conditions there. The remote server is configured: (A) to determine, based on the data obtained and analyzed in (a), that said appliance was located at a particular geographic region since the time-of-purchase of said appliance until said post-purchase evaluation time-point; (B) to generate said premium amount for said Warranty Proposal, by taking into account a determination in (A) of said particular geographic region and by further taking into account data about weather conditions in said particular geographic region since the time-of-purchase of said appliance until said post-purchase evaluation time-point.

Some embodiments may utilize the geographic location with Machine Learning of typical (or average, or estimated, or predicted) number of days until failure of the Appliance. For example, the remote server is configured: (A) to determine, based on the data obtained and analyzed in (a), that said appliance was located at a particular geographic region since the time-of-purchase of said appliance until said post-purchase evaluation time-point; (B) to perform a Machine Learning (ML) process that generates, for each type and model of appliance in combination with a geographic region, a probability that the appliance has already malfunctioned within D days, wherein D is the number of days since the time-of-purchase of said appliance until said post-purchase evaluation time-point; (C) to generate said premium amount for said Warranty Proposal, by taking into account a determination in (B) of said probability that the appliance has already malfunctioned.

Some embodiments may take into account the temperature(s) measured within the Venue in which the Appliance and/or the Consumer is (or are) located. The remote server is configured: (A) to determine, based on the data obtained and analyzed in (a), that said appliance was located at a particular venue since delivery of said appliance to said user until said post-purchase evaluation time-point; (B) to obtain, from an Internet-connected device that is located in said particular venue, one or more measurements of temperature in said venue, during at least a portion of time-period that is between the time-of-purchase of said appliance until said post-purchase evaluation time-point; (C) to analyze said one or more measurements of temperature in said venue, and to determine that there is a probability value P1 that said appliance has already malfunctioned due to temperatures in said venue, based on pre-defined rules that associate between (I) a type-and-model of appliances, and (ii) ranges of temperatures that are suitable for error-free operation of appliances; (D) to generate said premium amount for said Warranty Proposal, by taking into account a determination in (C) of the probability value P1 that said appliance has already malfunctioned due to temperatures in said venue.

Some embodiments may remotely estimate, and may remotely take into account, the number of power outages in that venue and/or their average time-length and/or their cumulative time-length. The remote server is configured: (A) to determine, based on the data obtained and analyzed in (a), that said appliance was located at a particular venue since delivery of said appliance to said user until said post-purchase evaluation time-point; (B) to obtain, from an Internet-connected device that is located in said particular venue, a number or a frequency of power outages in said venue; (C) to generate said premium amount for said Warranty Proposal, by taking into account a rule that associates between (I) a number or a frequency of power outages in said particular venue, and (II) a probability that said appliance has already malfunctioned.

Some embodiments may utilize acoustic analysis and/or audio analysis to detect malfunction and/or abuse and/or mis-use of the Appliance. The remote server is configured: (A) to determine, based on the data obtained and analyzed in (a), that said appliance was located at a particular venue since delivery of said appliance to said user until said post-purchase evaluation time-point; (B) to obtain, from an Internet-connected device that is located in said particular venue and that is equipped with an acoustic microphone, one or more audio recordings of audio recorded in said particular venue; (C) to analyze said one or more audio recordings, that were obtained from said Internet-connected device that is located in said particular venue; and to detect therein an audio segment indicating that said appliance has malfunctioned; (D) to generate said premium amount for said Warranty Proposal, by taking into account a determination in (C) that said appliance has malfunctioned, wherein said determination in (C) was reached by analysis of said one or more audio recordings that were obtained from said Internet-connected device that is located in said particular venue.

Some embodiments may further take into account Product Reviews (or scores, or ratings, or rankings, or other consumer reviews) to predict or estimate the current condition of the Appliance and/or the number of days until its estimated failure or malfunction and/or whether it is a suitable appliance to be subject for proposal of warranty or insurance. An AI engine and/or a contextual analysis engine and/or a textual analysis engine may search and detect particular keywords that appear in such user reviews (e.g., “broke” or “broke down” or “broken” or “malfunctioned” or “horrible product”; or conversely, “very satisfied” or “reliable” or “works flawlessly”, and their frequency, optionally utilizing a weighted formula to take them into account (e.g., one negative review that mentions “horrible” and “broke down”, may be assigned a triple weight relative to a positive review that mentions “satisfactory”), or to other detect or estimate “user sentiment” in such reviews or to deduce it from such reviews; on a per-Appliance, per-model basis. For example, the remote server is configured: (A) to determine, based on the data obtained from said appliance or from a user of said appliance, that D days have passed from the time-of-purchase of said appliance until said post-purchase evaluation time-point; (B) to perform contextual analysis of product reviews that pertain to a particular type-and-model said appliance, and to determine that at least N percent of said product reviews indicate that said type-and-model of appliance typically malfunctions within D days of purchase; wherein N is a pre-defined threshold value that is configured per device type and model; (C) to generate said premium amount for said Warranty Proposal, by taking into account a determination in (B) that at least N percent of the product reviews indicate that said type-and-model of appliance typically malfunctions within D days of purchase.

Some embodiments may similarly detect, and take into account, user reviews that mention or hint towards the number of usage days that have elapsed without appliance malfunction; for example, detecting a consumer review that mentions “I have used this coffee machine every day for 11 months and it works flawlessly”, and utilizing such data in order to support a decision to offer a nine-months warranty period for a similar coffee machine that is estimated (or known) to be one month old. The remote server is configured: (A) to determine, based on the data obtained from said appliance or from a user of said appliance or from a vendor of said appliance, that D days have passed from the time-of-purchase of said appliance until said post-purchase evaluation time-point; (B) to perform contextual analysis of product reviews that pertain to a particular type-and-model said appliance, and to determine that at least K percent of said product reviews indicate that said type-and-model of appliance typically does not malfunction within D days of purchase; wherein K is a pre-defined threshold value that is configured per device type and model; (C) to generate said premium amount for said Warranty Proposal, by taking into account a determination in (B) that at least K percent of the product reviews indicate that said type-and-model of appliance typically does not malfunction within D days of purchase.

Some embodiments may utilize a Machine Learning (ML) engine, which may receive several parameters, to estimate remotely the operational condition of the Appliance. For example, the remote server is configured: (A) to determine, based on the data obtained from said appliance or from a user of said appliance or from a vendor of said appliance, that D days have passed from the time-of-purchase of said appliance until said post-purchase evaluation time-point; (B) to perform a Machine Learning (ML) process that generates, for said appliance, a probability value P1 that the appliance has already malfunctioned within the D days that have passed since the time-of-purchase of said appliance; wherein the Machine Learning process takes into account at least: (B1) a type and a model of said appliance, and (B2) a number of minutes that said appliance was in actual use, regardless of being offline or online; and (B3) a number of minutes that said appliance was in actual use, regardless of being offline or online; and (B4) a geographic region in which said appliance is currently located or was purchased, and (B5) data about current or past weather conditions in said geographic region; and then, (C) to generate said premium amount for said Warranty Proposal, by taking into account a determination in (B) of the probability value P1 that the appliance has already malfunctioned within the D days that have passed since the time-of-purchase of said appliance.

In some embodiments, the appliance is an appliance selected from the group consisting of: a fridge, a freezer; wherein the one or more processors are configured: (A) to obtain from said appliance a total number of minutes M in which a door of said appliance was open; (B) to determine a number of days D that passed from the time-of-purchase of said appliance until said post-purchase evaluation time-point; (C) to generate said premium amount for said Warranty Proposal, by taking into account both (i) the total number of minutes M in which the door of said appliance was open, and (ii) the number of days D that passed from the time-of-purchase of said appliance until said post-purchase evaluation time-point.

In some embodiments, the system detects and takes into account, the actual usage of the appliance, as well as the number of times (and/or the frequency) of switching the appliance on and/or off. For example, the appliance is an appliance selected from the group consisting of: a fridge comprising a thermometer, a freezer comprising a thermometer, an air conditioning unit comprising a thermometer, a heating unit comprising a thermometer, an oven comprising a thermometer, a food-heating unit comprising a thermometer. The remote server is configured: (A) to obtain from said appliance a plurality of temperature readings sensed by said thermometer; (B) to perform an analysis of said temperature readings sensed by said thermometer, and to determine that an abnormal fluctuation of temperature has occurred prior to said post-purchase evaluation time-point; (C) to generate said premium amount for said Warranty Proposal, by taking into account a determination in (B) that an abnormal fluctuation of temperature has occurred prior to said post-purchase evaluation time-point.

In some embodiments, the system may take into account that the appliance was over-used, or was used excessively (e.g., relative to a baseline threshold value); for example, detecting that a coffee machine is used 36 times per day and not 4 times per day, or detecting that a water heater or water boiler is re-filled and fully used 12 times per day, or the like. For example, the appliance is selected from the group consisting of: a water heater comprising a water storage tank; a coffee machine comprising a water storage tank; an espresso machine comprising a water storage tank; a soda machine comprising a water storage tank; a beverage machine comprising a water storage tank. For example, the remote server and its one or more processors are configured: (A) to obtain from said appliance a plurality of measurements of a water level within said water storage tank, at a plurality of time-points; (B) to perform an analysis of said measurements of a water level within said water storage tank, and to determine that fluctuation of the water level within said water storage tank indicate that said appliance is utilized excessively relative to a pre-defined baseline utilization profile; (C) to generate said premium amount for said Warranty Proposal, by taking into account a determination in (B) that fluctuation of the water level within said water storage tank indicates that said appliance was utilized excessively.

Some embodiments may estimate and may take into account past electric power fluctuation. For example, the appliance is selected from the group consisting of: an appliance capable of measuring and reporting its own electric power consumption, an appliance that is plugged-in into a smart power outlet that is capable of measuring and reporting electric power consumed through said smart power outlet. The remote server or its processors are configured: (A) to obtain a plurality of measurements of electric power consumed by said appliance, over a time period that begins at the time-of-purchase of said appliance and that ends at said post-purchase evaluation time-point; (B) to perform an analysis of said measurements of electric power consumed by said appliance, and to determine that said appliance has malfunctioned prior to said post-purchase evaluation time-point; (C) to generate said premium amount for said Warranty Proposal, by taking into account a determination in (B) that said appliance has malfunctioned prior to said post-purchase evaluation time-point.

Some embodiments may estimate, and may take into account, the current power level as well as hints or determinations which may be deduced from it in order to estimate the current condition of the appliance and/or to estimate or predict an appliance malfunction. For example, the appliance is selected from the group consisting of: an appliance capable of measuring and reporting an electric current level that is currently being consumed by said appliance; an appliance that is plugged-in into a smart power outlet that is capable of measuring and reporting an electric current level that is currently being consumed by said appliance. The remote server is configured: (A) to obtain a measurement of the electric current level that is currently being consumed by said appliance, at said post-purchase evaluation time-point; (B) to determine, remotely and externally to said appliance, that said appliance is currently malfunctioning, based on pre-defined rules, that are pre-defined per appliance type-and-model, and that correlate between (I) a range of values of electric current, and (II) an existence of a malfunction in said appliance; (C) to generate said premium amount for said Warranty Proposal, by taking into account a determination in (B) that said appliance is currently malfunctioning.

Some embodiments may take into account that an excessive number of users (e.g., relative to a pre-defined threshold value, per appliance and/or per appliance type and/or per model) is utilizing the appliance, based on reports by the appliance's owner. For example, the remote server is configured: (A) to determine a number of persons that reside at a venue in which said appliance is located, based on input received from an owner or a user of said appliance, indicating said number of persons; (B) to generate said premium amount for said Warranty Proposal, by taking into account the number of persons that are determined in (A) as residing in said venue, and by taking into account a rule that increases said premium amount if said number of persons increases.

Some embodiments may take into account that an excessive number of users (e.g., relative to a pre-defined threshold value, per appliance and/or per appliance type and/or per model) is utilizing the appliance, based on audio analysis. For example, the remote server is configured: (A) to determine a number of persons that reside at a venue in which said appliance is located, based on an analysis of audio recordings, captured by an acoustic microphone of said appliance or of a co-located device, and based on utilization of an audio analysis process to determine a number of different speakers; (B) to generate said premium amount for said Warranty Proposal, by taking into account the number of persons that are determined in (A) as residing in said venue, and by taking into account a rule that increases said premium amount if said number of persons increases.

Some embodiments may take into account that an excessive number of users (e.g., relative to a pre-defined threshold value, per appliance and/or per appliance type and/or per model) is utilizing the appliance, based on image analysis of video analysis of footage acquired or transmitted by a camera or imager. For example, the remote server is configured: (A) to determine a number of persons that reside at a venue in which said appliance is located, based on an analysis of video footage or images, captured by a camera of said appliance or of a co-located device, and based on utilization of a computer vision process to determine a number of different persons that are depicted in said video footage or images; (B) to generate said premium amount for said Warranty Proposal, by taking into account the number of persons that are determined in (A) as residing in said venue, and by taking into account a rule that increases said premium amount if said number of persons increases.

Some embodiments may take into account that an excessive number of users (e.g., relative to a pre-defined threshold value, per appliance and/or per appliance type and/or per model) is utilizing the appliance, based on analysis of fingerprints (e.g., collected via a phone, a tablet, a touch-screen thermostat, a fingerprint reader that is embedded in a handle of a fridge door or a freezer door or an oven door or a microwave oven door or a dishwasher door or a laundry washer door or a dryer door, or the like. For example, the remote server is configured: (A) to determine a number of persons that reside at a venue in which said appliance is located, based on an analysis of human fingerprints that were scanned by a fingerprint scanner of said appliance or by a fingerprint scanner that is co-located in said venue; and based on utilization of a fingerprint analysis process to determine a number of different persons from said human fingerprints that were scanned; (B) to generate said premium amount for said Warranty Proposal, by taking into account the number of persons that are determined in (A) as residing in said venue, and by taking into account a rule that increases said premium amount if said number of persons increases.

In some embodiments, a system comprises: one or more processors, operably associated with one or more memory units; wherein the one or more processors are configured: (a) to obtain and analyze data pertaining to an appliance, at a post-purchase evaluation time-point that is subsequent to the time-of-purchase of said appliance; (b) based on the data obtained and analyzed in (a), to determine an Appliance Usage Score Value, indicating characteristics of a manner in which said appliance was utilized, since said time-of-purchase until said post-purchase evaluation time-point; (c) based on the Appliance Usage Score Value determined in (b), to automatically generate a post-purchase Warranty Proposal for a new warranty for said appliance, and to automatically generate a premium amount that is included in said post-purchase Warranty Proposal.

In some embodiments, the one or more processors are configured: (A) to determine, based on the data obtained and analyzed in (a), that said appliance was abused by a user of said appliance during at least one time-point that is between said time-of-purchase and said post-purchase evaluation time-point; (B) to generate said premium amount for said post-purchase Warranty Proposal, by taking into account a determination in (A) of a post-purchase abuse that was determined for said appliance.

In some embodiments, the one or more processors are configured: (A) to determine, based on the data obtained and analyzed in (a), that said appliance was properly utilized continuously by a user of said appliance during a time-period that begins at said time-of-purchase and that ends at said post-purchase evaluation time-point; (B) to generate said premium amount for said post-purchase Warranty Proposal, by taking into account a determination in (A) of post-purchase continuous proper utilization of said appliance by said user from said time-of-purchase until said post-purchase evaluation time-point.

In some embodiments, the one or more processors are configured: (A) to determine, based on the data obtained and analyzed in (a), that said appliance was not in use at all since the time-of-purchase of said appliance until the date of said post-purchase evaluation time-point; (B) to generate said premium amount for said post-purchase Warranty Proposal, by taking into account a determination in (A) that said appliance was not in used at all since the time-of-purchase of said appliance until the date of said post-purchase evaluation time-point.

In some embodiments, the one or more processors are configured: (A) to determine, based on the data obtained and analyzed in (a), that said appliance was in use for not more than M minutes cumulatively since the time-of-purchase of said appliance until said post-purchase evaluation time-point; wherein M is a threshold value that is pre-defined per type or per model of appliance; (B) to generate said premium amount for said post-purchase Warranty Proposal, by taking into account a determination in (A) that said appliance was in use for not more than M minutes cumulatively since the time-of-purchase of said appliance until said post-purchase evaluation time-point.

In some embodiments, the one or more processors are configured: (A) to determine, based on the data obtained and analyzed in (a), that said appliance was connected to the Internet for not more than M minutes cumulatively since the time-of-purchase of said appliance until said post-purchase evaluation time-point; wherein M is a threshold value that is pre-defined per type or per model of appliance; (B) to generate said premium amount for said post-purchase Warranty Proposal, by taking into account a determination in (A) that said appliance was connected to the Internet for not more than M minutes since the time-of-purchase of said appliance until said post-purchase evaluation time-point.

In some embodiments, the one or more processors are configured: (A) to determine, remotely and externally to said appliance, a cumulative number of minutes (M1) that said appliance was connected to the Internet since the time-of-purchase of said appliance until said post-purchase evaluation time-point; (B) to generate said premium amount for said post-purchase Warranty Proposal, by taking into account a determination in (A) of the cumulative number of minutes (M1) that said appliance was connected to the Internet since the time-of-purchase of said appliance until said post-purchase evaluation time-point.

In some embodiments, the one or more processors are configured: (A) to determine, remotely and externally to said appliance, a first cumulative number of minutes (M1) that said appliance was connected to the Internet since the time-of-purchase of said appliance until said post-purchase evaluation time-point; (B) to receive from said appliance, a message indicating a second, greater, cumulative number of minutes (M2) that said appliance was operable and in use, regardless of being offline or online, since the time-of-purchase of said appliance until said post-purchase evaluation time-point; (C) to generate said premium amount for said post-purchase Warranty Proposal, by taking into account both: (i) a determination in (A) of the first cumulative number of minutes (M1) that said appliance was connected to the Internet since the time-of-purchase of said appliance until said post-purchase evaluation time-point, and (ii) the second cumulative number of minutes (M2) in which said appliance was operable and in use regardless of being offline or online.

In some embodiments, the one or more processors are configured: (A) to determine, remotely and externally from the appliance, that said appliance was first-ever connected to the Internet on day D1; and (B) to detect that during a usage session of said appliance, which is the first-ever Internet-connected usage session of said appliance, the appliance was operated by a user to perform at least K different tasks within not more than M minutes; wherein K and M are threshold values that are pre-defined per type-and-model of appliance; (C) based on a detection in (B), to determine that said first-ever Internet-connected usage session, is also a first-ever usage session of said appliance as it exhibits a user attempt to try out various operational features of the appliance, and to determine that said appliance was not used at all by said user prior to said day D1; and (D) to generate said premium amount for said post-purchase Warranty Proposal, by taking into account a determination in (C) that said first-ever Internet-connected usage session is also a first-ever usage session of said appliance.

In some embodiments, the one or more processors are configured: (A) to determine, based on the data obtained and analyzed in (a), that said appliance was located at a particular geographic region since delivery of said appliance to a consumer until said post-purchase evaluation time-point; (B) to generate said premium amount for said post-purchase Warranty Proposal, by taking into account a determination in (A) of said particular geographic region in which said appliance was located since delivery.

In some embodiments, the one or more processors are configured: (A) to determine, based on the data obtained and analyzed in (a), that said appliance was located at a particular geographic region since initial delivery of said appliance until said post-purchase evaluation time-point; (B) to generate said premium amount for said post-purchase Warranty Proposal, by taking into account a determination in (A) of said particular geographic region and by further taking into account data about weather conditions in said particular geographic region since delivery date until said post-purchase evaluation time-point.

In some embodiments, the one or more processors are configured: (A) to determine, based on the data obtained and analyzed in (a), that said appliance was located at a particular geographic region since delivery of said appliance until said post-purchase evaluation time-point; (B) to perform a Machine Learning (ML) process that generates, for each type and model of appliance in combination with a geographic region, a probability that the appliance has already malfunctioned within D days, wherein D is the number of days since time-of-purchase of said appliance; (C) to generate said premium amount for said post-purchase Warranty Proposal, by taking into account a determination in (B) of said probability that the appliance has already malfunctioned.

In some embodiments, the one or more processors are configured: (A) to determine, based on the data obtained and analyzed in (a), that said appliance was located at a particular venue since delivery of said appliance until said post-purchase evaluation time-point; (B) to obtain, from an Internet-connected device that is located in said particular venue, one or more measurements of temperature in said particular venue, during at least a portion of time-period that is between the time-of-purchase of said appliance until said post-purchase evaluation time-point; (C) to analyze said one or more measurements of temperature that were measured in said particular venue, and to determine that there is a probability value P1 that said appliance has already malfunctioned due to temperatures in said particular venue, based on pre-defined rules that associate between (I) a type-and-model of different appliances, and (ii) ranges of temperatures that are suitable for error-free operation of different appliances; (D) to generate said premium amount for said post-purchase Warranty Proposal, by taking into account a determination in (C) of the probability value P1 that said appliance has already malfunctioned due to temperatures in said particular venue.

In some embodiments, the one or more processors are configured: (A) to determine, based on the data obtained and analyzed in (a), that said appliance was located at a particular venue since delivery of said appliance to said user until said post-purchase evaluation time-point; (B) to obtain, from an Internet-connected device that is located in said particular venue, and that is not said appliance, a number or a frequency of power outages in said particular venue; (C) to generate said premium amount for said post-purchase Warranty Proposal, by taking into account a rule that associates between (I) a number or a frequency of power outages in said particular venue, and (II) a probability that said appliance has already malfunctioned.

In some embodiments, the one or more processors are configured: (A) to determine, based on the data obtained and analyzed in (a), that said appliance was located at a particular venue since delivery of said appliance to said user until said post-purchase evaluation time-point; (B) to obtain, from an Internet-connected device that is located in said particular venue and that is equipped with an acoustic microphone, and that is not said appliance, one or more audio recordings of audio recorded in said particular venue; (C) to analyze said one or more audio recordings, that were obtained from said Internet-connected device that is located in said particular venue and that is not said appliance; and to detect therein an audio segment indicating that said appliance has malfunctioned; (D) to generate said premium amount for said post-purchase Warranty Proposal, by taking into account a determination in (C) that said appliance has malfunctioned, wherein said determination in (C) was reached by analysis of said one or more audio recordings that were obtained from said Internet-connected device that is located in said particular venue and that is not said appliance.

In some embodiments, the one or more processors are configured: (A) to determine, based on the data obtained (i) from said appliance or (ii) from a user of said appliance or (iii) from a sales record that pertains to a sale of said appliance to said user, that D days have passed from the time-of-purchase of said appliance until said post-purchase evaluation time-point;

(B) to perform contextual analysis of product reviews that pertain to a particular type-and-model of appliance, and to determine that at least N percent of said product reviews indicate that said type-and-model of appliance typically malfunctions within D days of purchase; wherein N is a pre-defined threshold value that is configured per device type and model; (C) to generate said premium amount for said post-purchase Warranty Proposal, by taking into account a determination in (B) that at least N percent of the product reviews indicate that said type-and-model of appliance typically malfunctions within D days of purchase.

In some embodiments, the one or more processors are configured: (A) to determine, based on the data obtained (i) from said appliance or (ii) from a user of said appliance or (iii) from a sales record that pertains to a sale of said appliance to said user, that D days have passed from the time-of-purchase of said appliance until said post-purchase evaluation time-point; (B) to perform contextual analysis of product reviews that pertain to a particular type-and-model of appliance, and to determine that at least K percent of said product reviews indicate that said type-and-model of appliance typically does not malfunction within D days of purchase; wherein K is a pre-defined threshold value that is configured per device type and model; (C) to generate said premium amount for said post-purchase Warranty Proposal, by taking into account a determination in (B) that at least K percent of the product reviews indicate that said type-and-model of appliance typically does not malfunction within D days of purchase.

In some embodiments, the one or more processors are configured: (A) to determine, based on the data obtained (i) from said appliance or (ii) from a user of said appliance or (iii) from a sales record that pertains to a sale of said appliance to said user, that D days have passed from the time-of-purchase of said appliance until said post-purchase evaluation time-point; (B) to perform a Machine Learning (ML) process that generates, for said appliance, a probability value P1 that said appliance has already malfunctioned within the D days that have passed since the time-of-purchase of said appliance; wherein the Machine Learning process takes into account at least: (B1) a type and a model of said appliance, and (B2) a cumulative number of minutes that said appliance was in actual use, regardless of being offline or online; and (B3) a cumulative number of minutes that said appliance was in actual use, regardless of being offline or online; and (B4) a geographic region in which said appliance is currently located or was purchased, and (B5) data about current or past weather conditions in said geographic region; (C) to generate said premium amount for said post-purchase Warranty Proposal, by taking into account a determination in (B) of the probability value P1 that the appliance has already malfunctioned within the D days that have passed since the time-of-purchase of said appliance.

In some embodiments, said appliance is an appliance selected from the group consisting of: a fridge, a freezer; wherein the one or more processors are configured: (A) to obtain from said appliance a cumulative number of minutes M in which a door of said appliance was open; (B) to generate said premium amount for said post-purchase Warranty Proposal, by taking into account said cumulative number of minutes M in which the door of said appliance was open.

In some embodiments, said appliance is an appliance selected from the group consisting of: a fridge comprising a thermometer, a freezer comprising a thermometer, an air conditioning unit comprising a thermometer, a heating unit comprising a thermometer, an oven comprising a thermometer, a food-heating unit comprising a thermometer; wherein the one or more processors are configured: (A) to obtain from said appliance a plurality of temperature readings sensed by said thermometer of said appliance; (B) to perform an analysis of said temperature readings sensed by said thermometer of said appliance, and to determine that an abnormal fluctuation of temperature has occurred prior to said post-purchase evaluation time-point; (C) to generate said premium amount for said post-purchase Warranty Proposal, by taking into account a determination in (B) that an abnormal fluctuation of temperature has occurred prior to said post-purchase evaluation time-point.

In some embodiments, said appliance is an appliance selected from the group consisting of: a water heater comprising a water storage tank; a coffee machine comprising a water storage tank; an espresso machine comprising a water storage tank; a soda machine comprising a water storage tank; a beverage machine comprising a water storage tank; wherein the one or more processors are configured: (A) to obtain from said appliance a plurality of measurements of a water level within said water storage tank of said appliance, at a plurality of time-points; (B) to perform an analysis of said measurements of a water level within said water storage tank of said appliance, and to determine that fluctuation of the water level within said water storage tank of said appliance indicates that said appliance is utilized excessively relative to a pre-defined baseline utilization profile; (C) to generate said premium amount for said post-purchase Warranty Proposal, by taking into account a determination in (B) that fluctuation of the water level within said water storage tank of said appliance indicates that said appliance was utilized excessively.

In some embodiments, said appliance is an appliance selected from the group consisting of: (I) an appliance capable of measuring and reporting its own electric power consumption, (II) an appliance that is plugged-in into a smart power outlet that is capable of measuring and reporting electric power consumed through said smart power outlet; wherein the one or more processors are configured: (A) to obtain a plurality of measurements of electric power consumed by said appliance, over a time period that begins at the time-of-purchase of said appliance and that ends at said post-purchase evaluation time-point; (B) to perform an analysis of said measurements of electric power consumed by said appliance, and to determine based on said measurements that said appliance has malfunctioned prior to said post-purchase evaluation time-point; (C) to generate said premium amount for said post-purchase Warranty Proposal, by taking into account a determination in (B) that said appliance has malfunctioned prior to said post-purchase evaluation time-point.

In some embodiments, said appliance is an appliance selected from the group consisting of: (I) an appliance capable of measuring and reporting an electric current level that is currently being consumed by said appliance, (II) an appliance that is plugged-in into a smart power outlet that is capable of measuring and reporting an electric current level that is currently being consumed by said appliance; wherein the one or more processors are configured: (A) to obtain a measurement of the electric current level that is currently being consumed by said appliance, at said post-purchase evaluation time-point; (B) to determine, remotely and externally to said appliance, that said appliance is currently malfunctioning, based on pre-defined rules, that are pre-defined per appliance type-and-model, and that correlate between (I) ranges of values of consumed electric current, and (II) an existence of a malfunction in said appliance; (C) to generate said premium amount for said post-purchase Warranty Proposal, by taking into account a determination in (B) that said appliance is currently malfunctioning.

In some embodiments, the one or more processors are configured: (A) to determine a number of persons that reside at a particular venue in which said appliance is located, based on input received from an owner or a user of said appliance, wherein said input indicates said number of persons; (B) to generate said premium amount for said post-purchase Warranty Proposal, by taking into account the number of persons that are determined in (A) as residing in said particular venue, and by taking into account a rule that increases said premium amount if said number of persons increases.

In some embodiments, the one or more processors are configured: (A) to determine a number of persons that are utilizing said appliance at a particular venue in which said appliance is located, based on an analysis of audio recordings, captured by an acoustic microphone of said appliance or of a co-located electronic device, and based on an audio analysis process that performs speaker differentiation and determines a number of different speakers; (B) to generate said premium amount for said post-purchase Warranty Proposal, by taking into account the number of persons that are determined in (A) as utilizing said appliance at said particular venue, and by taking into account a rule that increases said premium amount if said number of persons increases.

In some embodiments, the one or more processors are configured: (A) to determine a number of persons that that are utilizing said appliance at a particular venue in which said appliance is located, based on an analysis of video or images that are captured by a camera of said appliance or of a co-located electronic device, and based on a computer vision process that determines a number of different persons that are depicted in said video or images; (B) to generate said premium amount for said post-purchase Warranty Proposal, by taking into account the number of persons that are determined in (A) as utilizing said appliance at said particular venue, and by taking into account a rule that increases said premium amount if said number of persons increases.

In some embodiments, the one or more processors are configured: (A) to determine a number of persons that are utilizing the appliance at a particular venue in which said appliance is located, based on an analysis of human fingerprints that were sensed by a fingerprint sensor of said appliance, and based on a fingerprint analysis process that determines the number of different persons from said human fingerprints that were sensed; (B) to generate said premium amount for said post-purchase Warranty Proposal, by taking into account the number of persons that are determined in (A) as utilizing said appliance at said particular venue, and by taking into account a rule that increases said premium amount if said number of persons increases.

Some embodiments may include a non-transitory storage medium or storage article having stored thereon instructions or code that, when executed by a machine or a hardware processor, cause such machine or hardware processor to perform a method as described.

Some implementations may utilize an automated method or automated process, or a machine-implemented method or process, or as a semi-automated or partially-automated method or process, or as a set of steps or operations which may be executed or performed by a computer or machine or system or other device.

Some implementations may utilize code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), Register-Transfer Level (RTL), BASIC, Visual BASIC, Matlab, Pascal, HTML, HTML5, CSS, Perl, Python, PHP, machine language, machine code, assembly language, or the like.

Discussions herein utilizing terms such as, for example, “processing”, “computing”, “calculating”, “generating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some implementations may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), or the like.

Some implementations may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some implementations may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

Functions, operations, components and/or features described herein with reference to one or more implementations, may be combined with, or may be utilized in combination with, one or more other functions, operations, components and/or features described herein with reference to one or more other implementations. Some embodiments may comprise any possible or suitable combinations, re-arrangements, assembly, re-assembly, or other utilization of some or all of the modules or functions or components or units that are described herein, even if they are discussed in different locations or different chapters of the above discussion, or even if they are shown across different drawings or multiple drawings.

While certain features of some demonstrative embodiments have been illustrated and described herein, various modifications, substitutions, changes, and equivalents may occur to those skilled in the art. Accordingly, the claims are intended to cover all such modifications, substitutions, changes, and equivalents.

What is claimed is:

1. A system comprising:
one or more processors, operably associated with one or more memory units;
wherein the one or more processors are configured:
(a) to obtain and analyze data pertaining to an appliance, at a post-purchase evaluation time-point that is subsequent to the time-of-purchase of said appliance;
(b) based on the data obtained and analyzed in (a), to determine an Appliance Usage Score Value, indicating characteristics of a manner in which said appliance was utilized, since said time-of-purchase until said post-purchase evaluation time-point;
(c) based on the Appliance Usage Score Value determined in (b), to automatically generate a post-purchase Warranty Proposal for a new warranty for said appliance, and to automatically generate a premium amount that is included in said post-purchase Warranty Proposal.

2. The system of claim 1,
wherein the one or more processors are configured:
(A) to determine, based on the data obtained and analyzed in (a), that said appliance was abused by a user of said appliance during at least one time-point that is between said time-of-purchase and said post-purchase evaluation time-point;
(B) to generate said premium amount for said post-purchase Warranty Proposal, by taking into account a determination in (A) of a post-purchase abuse that was determined for said appliance.

3. The system of claim 1,
wherein the one or more processors are configured:
(A) to determine, based on the data obtained and analyzed in (a), that said appliance was properly utilized continuously by a user of said appliance during a time-period that begins at said time-of-purchase and that ends at said post-purchase evaluation time-point;
(B) to generate said premium amount for said post-purchase Warranty Proposal, by taking into account a determination in (A) of post-purchase continuous proper utilization of said appliance by said user from said time-of-purchase until said post-purchase evaluation time-point.

4. The system of claim 1,
wherein the one or more processors are configured:
(A) to determine, based on the data obtained and analyzed in (a), that said appliance was not in use at all since the time-of-purchase of said appliance until the date of said post-purchase evaluation time-point;
(B) to generate said premium amount for said post-purchase Warranty Proposal, by taking into account a determination in (A) that said appliance was not in used at all since the time-of-purchase of said appliance until the date of said post-purchase evaluation time-point.

5. The system of claim 1,
wherein the one or more processors are configured:
(A) to determine, based on the data obtained and analyzed in (a), that said appliance was in use for not more than M minutes cumulatively since the time-of-purchase of said appliance until said post-purchase evaluation time-point; wherein M is a threshold value that is pre-defined per type or per model of appliance;
(B) to generate said premium amount for said post-purchase Warranty Proposal, by taking into account a determination in (A) that said appliance was in use for not more than M minutes cumulatively since the time-of-purchase of said appliance until said post-purchase evaluation time-point.

6. The system of claim 1,
wherein the one or more processors are configured:
(A) to determine, based on the data obtained and analyzed in (a), that said appliance was connected to the Internet for not more than M minutes cumulatively since the time-of-purchase of said appliance until said post-purchase evaluation time-point; wherein M is a threshold value that is pre-defined per type or per model of appliance;
(B) to generate said premium amount for said post-purchase Warranty Proposal, by taking into account a determination in (A) that said appliance was connected to the Internet for not more than M minutes since the time-of-purchase of said appliance until said post-purchase evaluation time-point.

7. The system of claim 1,
wherein the one or more processors are configured:
(A) to determine, remotely and externally to said appliance, a cumulative number of minutes (M1) that said appliance was connected to the Internet since the time-of-purchase of said appliance until said post-purchase evaluation time-point;
(B) to generate said premium amount for said post-purchase Warranty Proposal, by taking into account a determination in (A) of the cumulative number of minutes (M1) that said appliance was connected to the Internet since the time-of-purchase of said appliance until said post-purchase evaluation time-point.

8. The system of claim 1,
wherein the one or more processors are configured:
(A) to determine, remotely and externally to said appliance, a first cumulative number of minutes (M1) that said appliance was connected to the Internet since the time-of-purchase of said appliance until said post-purchase evaluation time-point;
(B) to receive from said appliance, a message indicating a second, greater, cumulative number of minutes (M2) that said appliance was operable and in use, regardless of being offline or online, since the time-of-purchase of said appliance until said post-purchase evaluation time-point;
(C) to generate said premium amount for said post-purchase Warranty Proposal, by taking into account both: (i) a determination in (A) of the first cumulative number of minutes (M1) that said appliance was connected to the Internet since the time-of-purchase of said appliance until said post-purchase evaluation time-point, and (ii) the second cumulative number of minutes (M2) in which said appliance was operable and in use regardless of being offline or online.

9. The system of claim 1,
wherein the one or more processors are configured:
(A) to determine, remotely and externally from the appliance, that said appliance was first-ever connected to the Internet on day D1;
(B) to detect that during a usage session of said appliance, which is the first-ever Internet-connected usage session of said appliance, the appliance was operated by a user to perform at least K different tasks within not more than M minutes; wherein K and M are threshold values that are pre-defined per type-and-model of appliance;
(C) based on a detection in (B), to determine that said first-ever Internet-connected usage session, is also a first-ever usage session of said appliance as it exhibits a user attempt to try out various operational features of the appliance, and to determine that said appliance was not used at all by said user prior to said day D1;
(D) to generate said premium amount for said post-purchase Warranty Proposal, by taking into account a determination in (C) that said first-ever Internet-connected usage session is also a first-ever usage session of said appliance.

10. The system of claim 1,
wherein the one or more processors are configured:
(A) to determine, based on the data obtained and analyzed in (a), that said appliance was located at a particular geographic region since delivery of said appliance to a consumer until said post-purchase evaluation time-point;
(B) to generate said premium amount for said post-purchase Warranty Proposal, by taking into account a determination in (A) of said particular geographic region in which said appliance was located since delivery.

11. The system of claim 1,
wherein the one or more processors are configured:
(A) to determine, based on the data obtained and analyzed in (a), that said appliance was located at a particular geographic region since initial delivery of said appliance until said post-purchase evaluation time-point;
(B) to generate said premium amount for said post-purchase Warranty Proposal, by taking into account a determination in (A) of said particular geographic region and by further taking into account data about weather conditions in said particular geographic region since delivery date until said post-purchase evaluation time-point.

12. The system of claim 1,
wherein the one or more processors are configured:
(A) to determine, based on the data obtained and analyzed in (a), that said appliance was located at a particular geographic region since delivery of said appliance until said post-purchase evaluation time-point;
(B) to perform a Machine Learning (ML) process that generates, for each type and model of appliance in combination with a geographic region, a probability that the appliance has already malfunctioned within D days, wherein D is the number of days since time-of-purchase of said appliance;
(C) to generate said premium amount for said post-purchase Warranty Proposal, by taking into account a determination in (B) of said probability that the appliance has already malfunctioned.

13. The system of claim 1,
wherein the one or more processors are configured:
(A) to determine, based on the data obtained and analyzed in (a), that said appliance was located at a particular venue since delivery of said appliance until said post-purchase evaluation time-point;
(B) to obtain, from an Internet-connected device that is located in said particular venue, one or more measurements of temperature in said particular venue, during at least a portion of time-period that is between the time-of-purchase of said appliance until said post-purchase evaluation time-point;
(C) to analyze said one or more measurements of temperature that were measured in said particular venue, and to determine that there is a probability value P1 that said appliance has already malfunctioned due to temperatures in said particular venue, based on pre-defined rules that associate between (I) a type-and-model of different appliances, and (ii) ranges of temperatures that are suitable for error-free operation of different appliances;
(D) to generate said premium amount for said post-purchase Warranty Proposal, by taking into account a determination in (C) of the probability value P1 that said appliance has already malfunctioned due to temperatures in said particular venue.

14. The system of claim 1,
wherein the one or more processors are configured:
(A) to determine, based on the data obtained and analyzed in (a), that said appliance was located at a particular venue since delivery of said appliance to said user until said post-purchase evaluation time-point;
(B) to obtain, from an Internet-connected device that is located in said particular venue, and that is not said appliance, a number or a frequency of power outages in said particular venue;
(C) to generate said premium amount for said post-purchase Warranty Proposal, by taking into account a rule that associates between (I) a number or a frequency of power outages in said particular venue, and (II) a probability that said appliance has already malfunctioned.

15. The system of claim 1,
wherein the one or more processors are configured:
(A) to determine, based on the data obtained and analyzed in (a), that said appliance was located at a particular venue since delivery of said appliance to said user until said post-purchase evaluation time-point;
(B) to obtain, from an Internet-connected device that is located in said particular venue and that is equipped with an acoustic microphone, and that is not said appliance, one or more audio recordings of audio recorded in said particular venue;
(C) to analyze said one or more audio recordings, that were obtained from said Internet-connected device that is located in said particular venue and that is not said appliance; and to detect therein an audio segment indicating that said appliance has malfunctioned;
(D) to generate said premium amount for said post-purchase Warranty Proposal, by taking into account a determination in (C) that said appliance has malfunctioned, wherein said determination in (C) was reached by analysis of said one or more audio recordings that were obtained from said Internet-connected device that is located in said particular venue and that is not said appliance.

16. The system of claim 1,
wherein the one or more processors are configured:
(A) to determine, based on the data obtained (i) from said appliance or (ii) from a user of said appliance or (iii) from a sales record that pertains to a sale of said appliance to said user, that D days have passed from the time-of-purchase of said appliance until said post-purchase evaluation time-point;
(B) to perform contextual analysis of product reviews that pertain to a particular type-and-model of appliance, and to determine that at least N percent of said product reviews indicate that said type-and-model of appliance typically malfunctions within D days of purchase; wherein N is a pre-defined threshold value that is configured per device type and model;
(C) to generate said premium amount for said post-purchase Warranty Proposal, by taking into account a determination in (B) that at least N percent of the product reviews indicate that said type-and-model of appliance typically malfunctions within D days of purchase.

17. The system of claim 1,
wherein the one or more processors are configured:
(A) to determine, based on the data obtained (i) from said appliance or (ii) from a user of said appliance or (iii) from a sales record that pertains to a sale of said appliance to said user, that D days have passed from the time-of-purchase of said appliance until said post-purchase evaluation time-point;
(B) to perform contextual analysis of product reviews that pertain to a particular type-and-model of appliance, and to determine that at least K percent of said product reviews indicate that said type-and-model of appliance typically does not malfunction within D days of purchase; wherein K is a pre-defined threshold value that is configured per device type and model;
(C) to generate said premium amount for said post-purchase Warranty Proposal, by taking into account a determination in (B) that at least K percent of the product reviews indicate that said type-and-model of appliance typically does not malfunction within D days of purchase.

18. The system of claim 1,
wherein the one or more processors are configured:
(A) to determine, based on the data obtained (i) from said appliance or (ii) from a user of said appliance or (iii) from a sales record that pertains to a sale of said appliance to said user, that D days have passed from the time-of-purchase of said appliance until said post-purchase evaluation time-point;
(B) to perform a Machine Learning (ML) process that generates, for said appliance, a probability value P1 that said appliance has already malfunctioned within the D days that have passed since the time-of-purchase of said appliance;
wherein the Machine Learning process takes into account at least:
(B1) a type and a model of said appliance, and
(B2) a cumulative number of minutes that said appliance was in actual use, regardless of being offline or online; and
(B3) a cumulative number of minutes that said appliance was in actual use, regardless of being offline or online; and
(B4) a geographic region in which said appliance is currently located or was purchased, and
(B5) data about current or past weather conditions in said geographic region;
(C) to generate said premium amount for said post-purchase Warranty Proposal, by taking into account a determination in (B) of the probability value P1 that the appliance has already malfunctioned within the D days that have passed since the time-of-purchase of said appliance.

19. The system of claim 1,
wherein said appliance is an appliance selected from the group consisting of: a fridge, a freezer;
wherein the one or more processors are configured:
(A) to obtain from said appliance a cumulative number of minutes M in which a door of said appliance was open;
(B) to generate said premium amount for said post-purchase Warranty Proposal, by taking into account said cumulative number of minutes M in which the door of said appliance was open.

20. The system of claim 1,
wherein said appliance is an appliance selected from the group consisting of:
a fridge comprising a thermometer,
a freezer comprising a thermometer,
an air conditioning unit comprising a thermometer,
a heating unit comprising a thermometer,
an oven comprising a thermometer,
a food-heating unit comprising a thermometer;
wherein the one or more processors are configured:
(A) to obtain from said appliance a plurality of temperature readings sensed by said thermometer of said appliance;
(B) to perform an analysis of said temperature readings sensed by said thermometer of said appliance, and to determine that an abnormal fluctuation of temperature has occurred prior to said post-purchase evaluation time-point;
(C) to generate said premium amount for said post-purchase Warranty Proposal, by taking into account a determination in (B) that an abnormal fluctuation of temperature has occurred prior to said post-purchase evaluation time-point.

21. The system of claim 1,
wherein said appliance is an appliance selected from the group consisting of:
a water heater comprising a water storage tank;
a coffee machine comprising a water storage tank;
an espresso machine comprising a water storage tank;
a soda machine comprising a water storage tank;
a beverage machine comprising a water storage tank;
wherein the one or more processors are configured:
(A) to obtain from said appliance a plurality of measurements of a water level within said water storage tank of said appliance, at a plurality of time-points;
(B) to perform an analysis of said measurements of a water level within said water storage tank of said appliance, and to determine that fluctuation of the water level within said water storage tank of said appliance indicates that said appliance is utilized excessively relative to a pre-defined baseline utilization profile;
(C) to generate said premium amount for said post-purchase Warranty Proposal, by taking into account a determination in (B) that fluctuation of the water level within said water storage tank of said appliance indicates that said appliance was utilized excessively.

22. The system of claim 1,
wherein said appliance is an appliance selected from the group consisting of:
(I) an appliance capable of measuring and reporting its own electric power consumption,
(II) an appliance that is plugged-in into a smart power outlet that is capable of measuring and reporting electric power consumed through said smart power outlet;
wherein the one or more processors are configured:
(A) to obtain a plurality of measurements of electric power consumed by said appliance, over a time period that begins at the time-of-purchase of said appliance and that ends at said post-purchase evaluation time-point;
(B) to perform an analysis of said measurements of electric power consumed by said appliance, and to determine based on said measurements that said appliance has malfunctioned prior to said post-purchase evaluation time-point;
(C) to generate said premium amount for said post-purchase Warranty Proposal, by taking into account a determination in (B) that said appliance has malfunctioned prior to said post-purchase evaluation time-point.

23. The system of claim 1,
wherein said appliance is an appliance selected from the group consisting of:
(I) an appliance capable of measuring and reporting an electric current level that is currently being consumed by said appliance,
(II) an appliance that is plugged-in into a smart power outlet that is capable of measuring and reporting an electric current level that is currently being consumed by said appliance;
wherein the one or more processors are configured:
(A) to obtain a measurement of the electric current level that is currently being consumed by said appliance, at said post-purchase evaluation time-point;
(B) to determine, remotely and externally to said appliance, that said appliance is currently malfunctioning, based on pre-defined rules, that are pre-defined per appliance type-and-model, and that correlate between (I) ranges of values of consumed electric current, and (II) an existence of a malfunction in said appliance;
(C) to generate said premium amount for said post-purchase Warranty Proposal, by taking into account a determination in (B) that said appliance is currently malfunctioning.

24. The system of claim 1,
wherein the one or more processors are configured:
(A) to determine a number of persons that reside at a particular venue in which said appliance is located, based on input received from an owner or a user of said appliance, wherein said input indicates said number of persons;
(B) to generate said premium amount for said post-purchase Warranty Proposal, by taking into account the number of persons that are determined in (A) as residing in said particular venue, and by taking into account a rule that increases said premium amount if said number of persons increases.

25. The system of claim 1,
wherein the one or more processors are configured:
(A) to determine a number of persons that are utilizing said appliance at a particular venue in which said appliance is located,
based on an analysis of audio recordings, captured by an acoustic microphone of said appliance or of a co-located electronic device, and based on an audio analysis process that performs speaker differentiation and determines a number of different speakers;
(B) to generate said premium amount for said post-purchase Warranty Proposal, by taking into account the number of persons that are determined in (A) as utilizing said appliance at said particular venue, and by taking into account a rule that increases said premium amount if said number of persons increases.

26. The system of claim 1,
wherein the one or more processors are configured:
(A) to determine a number of persons that that are utilizing said appliance at a particular venue in which said appliance is located,
based on an analysis of video or images that are captured by a camera of said appliance or of a co-located electronic device, and based on a computer vision process that determines a number of different persons that are depicted in said video or images;
(B) to generate said premium amount for said post-purchase Warranty Proposal, by taking into account the number of persons that are determined in (A) as utilizing said appliance at said particular venue, and by taking into account a rule that increases said premium amount if said number of persons increases.

27. The system of claim 1,
wherein the one or more processors are configured:
(A) to determine a number of persons that are utilizing the appliance at a particular venue in which said appliance is located,
based on an analysis of human fingerprints that were sensed by a fingerprint sensor of said appliance, and based on a fingerprint analysis process that determines the number of different persons from said human fingerprints that were sensed;
(B) to generate said premium amount for said post-purchase Warranty Proposal, by taking into account the number of persons that are determined in (A) as utilizing said appliance at said particular venue, and by taking into account a rule that increases said premium amount if said number of persons increases.
